(19) United States
(12) Patent Application Publication
(10) Pub. No.: US 2023/0162176 A1
(43) Pub. Date: May 25, 2023

(54) METHOD FOR IMPLEMENTING A DIGITAL COIN SYSTEM USING A BLOCKCHAIN

(71) Applicant: nChain Licensing AG, Zug (CH)

(72) Inventors: Michaella PETTIT, London (GB); Craig Steven WRIGHT, London (GB)

(21) Appl. No.: 17/919,995

(22) PCT Filed: Apr. 16, 2021
(86) PCT No.: PCT/EP2021/059929

§ 371 Date: Oct. 19, 2022

(30) Foreign Application Priority Data
Apr. 21, 2020 (GB) 2005791.5

(51) Int. Cl. G06Q 20/36; G06Q 20/38; G06Q 20/10; G06Q 20/40; H04L 9/00; H04L 9/32

(52) U.S. Cl. CPC G06Q 20/3678; G06Q 20/389; G06Q 20/10; G06Q 20/3829; G06Q 20/3827; G06Q 20/3825; G06Q 20/4014; H04L 9/50; H04L 9/3218; G06Q 2220/00

(57) ABSTRACT

A computer-implemented method for implementing a system for issuing digital coins using a blockchain, wherein each digital coin is issued by an issuing party and represents an amount of an asset redeemable by a redeeming party in exchange for the digital coin, wherein the issuing party maintains a record of coin serial numbers, each coin serial number representing a respective digital coin; the method being performed by the issuing party and comprising: obtaining a spending transaction comprising a first one of a set of coin serial numbers; determining whether the first coin serial number is present in the database; and in response to one or more conditions being met, transferring the amount of the asset represented by the first coin serial number to the redeeming party, wherein a first one of the conditions is that the first coin serial number is not present in the database.

### CROSS REFERENCE TO RELATED APPLICATIONS

This application is the U.S. National Stage of International Application No. PCT/EP2021/059929 filed on Apr. 16, 2021, which claims the benefit of United Kingdom Patent Application No. 2005791.5, filed on Apr. 21, 2020, the contents of which are incorporated herein by reference in their entireties.

### TECHNICAL FIELD

The present disclosure relates to a method for implementing a digital coin system for issuing digital coins using a blockchain.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence which may span one or more blocks. Transactions can be submitted to the network to be included in new blocks. New blocks are created by a process known as “mining”, which involves each of a plurality of mining nodes competing to perform “proof-of-work”, i.e. solving a cryptographic puzzle based on a pool of the pending transactions waiting to be included in blocks.

Transactions in the blockchain are used to convey a digital asset, i.e. a number of digital tokens. However, a blockchain can also be exploited in order to layer additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance this may be used to store an electronic document in the blockchain, or even audio or video data.

Each node in the network can have any one, two or all of three roles: forwarding, mining and storage. Forwarding nodes propagate transactions throughout the nodes of the network. Mining nodes perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, then the transaction (including any user data) will thus remain stored at each of the nodes in the P2P network as an immutable public record.

The miner who successfully solved the proof-of-work puzzle to create the latest block is typically rewarded with a new transaction called a “generation transaction” which generates a new amount of the digital asset. The proof-of work incentivises miners not to cheat the system by including double-spending transactions in their blocks, since it requires a large amount of compute resource to mine a block, and a block that includes an attempt to double-spend is likely not be accepted by other nodes.

In an “output-based” model (sometimes referred to as a UTXO-based model), the data structure of a given transaction comprises one or more inputs and one or more outputs. Any spendable output comprises an element specifying an amount of the digital asset, sometimes referred to as a UTXO (“unspent transaction output”). The output may further comprise a locking script specifying a condition for redeeming the output. Each input comprises a pointer to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the P2P network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it nor include it for mining into a block to be recorded in the blockchain.

Electronic cash (ecash) was first invented in 1983 (D. Chaum, “Blind signatures for untraceable payments,” Advances in cryptology, pp. 199-203, 1983.), and there have been many more implementations since then, but none of them have been able to replicate fiat cash systems. Note that ecash, in its conventional form does not utilize the blockchain.

### SUMMARY

One of the biggest problems with an ecash system (and digital coin systems in general) is that it is susceptible to ‘double-spending’, meaning that it is very easy to duplicate and spend the same ecash (or digital coin) again. This has prevented any of the previous systems becoming widely adopted

According to one aspect disclosed herein, there is provided a computer-implemented method for implementing a system for issuing digital coins using a blockchain, wherein each digital coin is issued by an issuing party to a spending party, wherein each digital coin represents an amount of an asset redeemable by a redeeming party in exchange for the digital coin, wherein the issuing party maintains a record of coin serial numbers, each coin serial number representing a respective digital coin; the method being performed by the issuing party and comprising: obtaining a spending transaction, the spending transaction being a blockchain transaction and comprising a first one of a set of coin serial numbers; determining whether the first coin serial number is present in the database of spent coin serial numbers; and in response to one or more conditions being met, transferring the amount of the asset represented by the first coin serial number to the redeeming party, wherein a first one of the one or more conditions is that the first coin serial number is not present in the database.

The issuing party maintains a list of coin serial numbers associated with spent digital coins. The issuing party may receive the spending transaction directly from the redeeming party, from the blockchain, or from another source. If the first coin serial number is present in the database, the corresponding digital coin has previously been spent and the spending party or the redeeming party is attempting to double-spend the coin. The issuing party will reject the digital coin. On the other hand, if the first coin serial number is not present in the database, the associated digital coin has not been spent before and the issuing party may accept the coin, which may be conditional on any other criteria being also met.

According to another aspect disclosed herein, there is provided a computer-implemented method for implementing a system for issuing digital coins using a blockchain, wherein each digital coin is issued by an issuing party to a spending party, and wherein each digital coin represents an amount of an asset redeemable by a redeeming party in exchange for the digital coin; the method being performed by the spending party and comprising: obtaining a withdrawal transaction, the withdrawal transaction comprising one or more outputs, each output comprising a hash of a respective one of a set of coin serial numbers, each coin serial number representing a respective digital coin; and transmitting the withdrawal transaction to the redeeming party, a third party, and/or to the blockchain network to be recorded in the blockchain.

The inclusion of the hash of the serial coin number in the output of the withdrawal transaction means that the serial coin number itself must be revealed in a transaction that attempts to unlock that output, thus forcing the coin serial number to be revealed by the spending party. The revealed coin serial number may be used to identify previously spent digital coin, and thus prevent double-spending of the digital coin.

The withdrawal transaction also acts as a record that the spending party has been issued with a set of digital coins, each coin having its own serial number. The withdrawal transaction may be issued by the issuing party to the spending party, and thus allow the issuing party to trace spent coins back to the spending party. Alternatively, the spending party may generate the withdrawal transaction.

According to another aspect disclosed herein, there is provided a computer-implemented method for implementing a system for issuing digital coins using a blockchain, wherein each digital coin is issued by an issuing party to a spending party, and wherein each digital coin represents an amount of an asset redeemable by a redeeming party in exchange for the digital coin; the method being performed by the redeeming party and comprising: obtaining, from the spending party, a first coin serial number; determining whether the first coin serial number is present on the blockchain; and in response to one or more conditions being met, obtaining a spending transaction, the spending transaction being a blockchain transaction and comprising the first coin serial number, and transmitting the spending transaction to one or more of: the spending party, the issuing party, a third party, and/or the blockchain network to be recorded in the blockchain, wherein a first one of the one or more conditions is that the first coin serial number is not present on the blockchain.

The redeeming party checks whether the first coin serial is present on the blockchain. As set out above, if the first coin serial number is present on the blockchain, it means that the spending party has previously spent the associated digital coin. If the first coin serial number is not present on the blockchain, the redeeming party can be confident that the associated digital coin has not been spent.

The present invention provides a system for implementing a digital coin system (e.g. an ecash system) on the blockchain. Advantageously, utilising the properties of the blockchain provides enhanced security of the digital coin system. In particular, the double-spend security of the proposed system is increased relative to previous systems due to two fundamental properties of the blockchain. The first property that is utilised is that transaction outputs have a binary state: spent or unspent. If an output represents a coin, then it is only accepted in the spend and deposit protocols of the system (described below) if the corresponding output is unspent. This property is used to prevent double-spending. The second property that is used is the fact that blockchains are distributed, immutable databases. The blockchain can be used to store spent and blacklisted coin serial numbers, that anyone may access if required.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of another system for implementing a blockchain,

FIG. 4A is a schematic block diagram of a client application,

FIG. 4B is a schematic block diagram of some node software for processing transactions,

FIG. 5 is a schematic block diagram of an example system for implementing an electronic cash protocol,

FIG. 6 is a schematic block diagram of an example system for implementing a digital coin system according to embodiments of the present invention,

FIGS. 7a and 7b schematically illustrate an example withdrawal transaction and corresponding data,

FIGS. 8a and 8b schematically illustrate an example spending transaction and corresponding data,

FIGS. 9a and 9b schematically illustrate an example deposit transaction and corresponding data,

FIGS. 10a and 10b schematically illustrate another example withdrawal transaction and corresponding data,

FIGS. 11a and 11b schematically illustrate another example spending transaction and corresponding data,

FIGS. 12a and 12b schematically illustrate another example deposit transaction and corresponding data,

FIGS. 13a to 13c schematically illustrate example withdrawal, spending and deposit transactions respectively,

FIGS. 14a to 14c schematically illustrate first examples of data for inserting into withdrawal, spending and deposit transactions respectively,

FIGS. 15a to 15c schematically illustrate second examples of data for inserting into withdrawal, spending and deposit transactions respectively,

FIGS. 16a to 16c schematically illustrate third examples of data for inserting into withdrawal, spending and deposit transactions respectively,

FIGS. 17a to 17c schematically illustrate fourth examples of data for inserting into withdrawal, spending and deposit transactions respectively,

FIGS. 18a to 18c schematically illustrate fifth examples of data for inserting into withdrawal, spending and deposit transactions respectively,

FIGS. 19a to 19c schematically illustrate sixth examples of data for inserting into withdrawal, spending and deposit transactions respectively, and

FIGS. 20a to 20c schematically illustrate seventh examples of data for inserting into withdrawal, spending and deposit transactions respectively.

### DETAILED DESCRIPTION OF EMBODIMENTS

Example System Overview

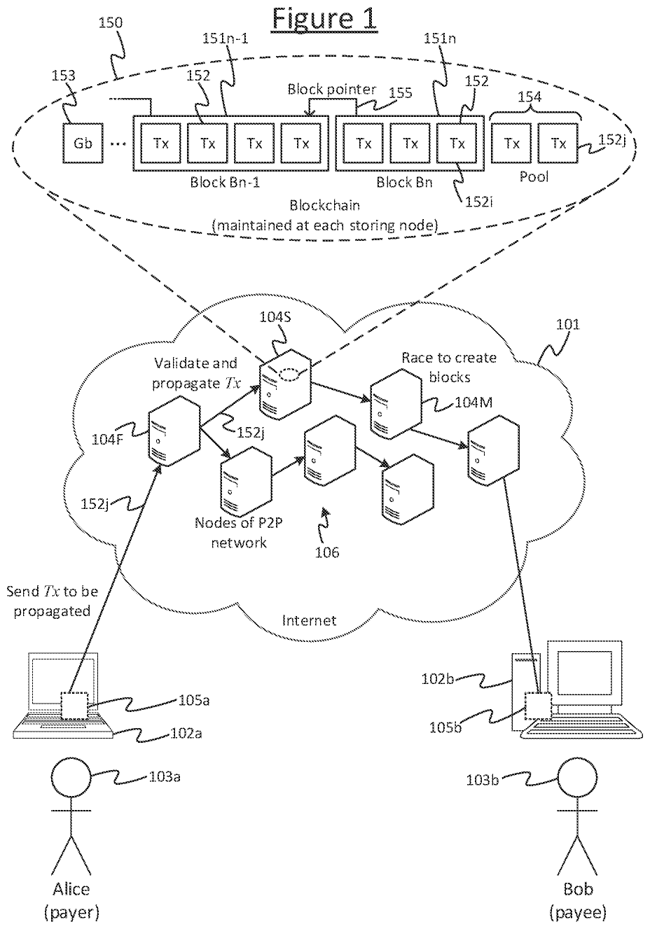

FIG. 1 shows an example system 100 for implementing a blockchain 150. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases a transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

With either type of transaction protocol, when a user 103 wishes to enact a new transaction 152j, then he/she sends the new transaction from his/her computer terminal 102 to one of the nodes 104 of the P2P network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transaction 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once. An account-based model on the other hand guards against double-spending by maintaining an account balance. Because again there is a defined order of transactions, the account balance has a single defined state at any one time.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n-1 in the chain. The proof-of-work helps reduce the risk of double-spending since it takes a large amount of effort to create a new block 151, and as any block containing a double-spend is likely to be rejected by other nodes 104, mining nodes 104M are incentivised not to allow double-spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. The node software may be implemented in one or more applications at the application layer, or a lower layer such as the operating system layer or a protocol layer, or any combination of these. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 (other than a generation transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different nodes 104 may receive different instances of a given transaction first and therefore have conflicting views of which instance is ‘valid’ before one instance is mined into a block 150, at which point all nodes 104 agree that the mined instance is the only valid instance. If a node 104 accepts one instance as valid, and then discovers that a second instance has been recorded in the blockchain 150 then that node 104 must accept this and will discard (i.e. treat as invalid) the unmined instance which it had initially accepted.

UTXO-Based Model

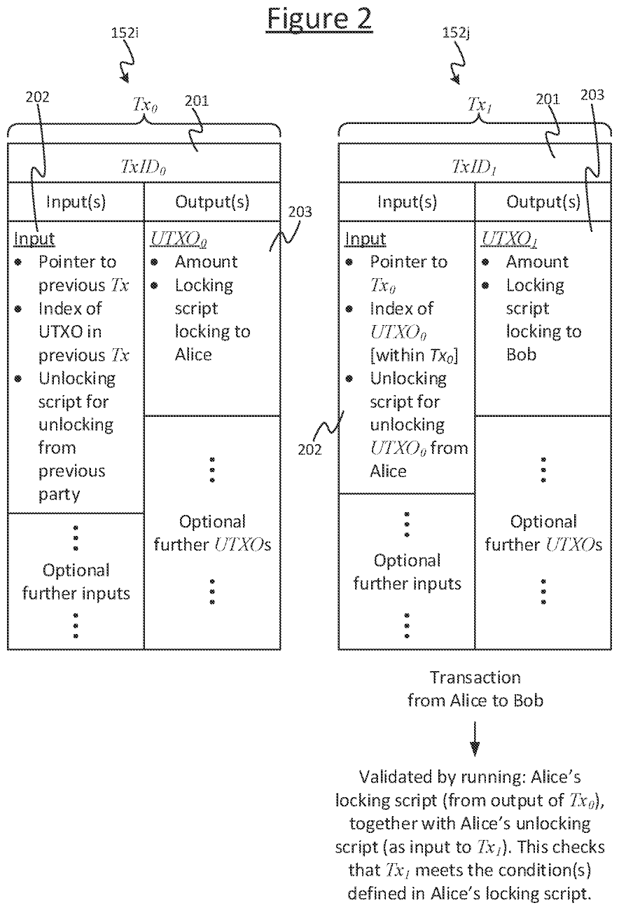

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the (distributed) ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just an arbitrary label. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in the blockchain 150 at the time when Alice creates her new transaction Tx₁, or at least by the time she sends it to the network 106. It may already have been included in one of the blocks 151 at that time, or it may be still waiting in the pool 154 in which case it will soon be included in a new block 151. Alternatively Tx₀ and Tx₁ could be created and sent to the network 102 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction Tx₁ arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the unlocking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the locking script in the input of Tx₁ contains the signature of Alice signing the expected portion of data. The expected portion of data itself (the “message”) also needs to be included in Tx₀ order to perform this authentication. In embodiments the signed data comprises the whole of Tx₀ (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the node 104 deems Tx₁ valid. If it is a mining node 104M, this means it will add it to the pool of transactions 154 awaiting proof-of-work. If it is a forwarding node 104F, it will forward the transaction Tx₁ to one or more other nodes 104 in the network 106, so that it will be propagated throughout the network. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the node 104 also needs to check whether the referenced UTXO in the preceding transaction Tx₀ is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor mined into blocks 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the winning miner, because nowadays the reward of the generation transaction alone is not typically sufficient to motivate mining. If Alice does not include a fee for the miner, Tx₀ will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to Tx₁, and Tx₁ has only one output UTXO₁. If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [Checksig P_{A}] to mean [Checking P_{A}]=OP_DUP OP_HASH160 <H(P_{A})> OP_EQUALVERIFY OP_CHECKSIG. “OP_ . . . ” refers to a particular opcode of the Script language. OP_CHECKSIG (also called “Checking”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

Optional Side Channel

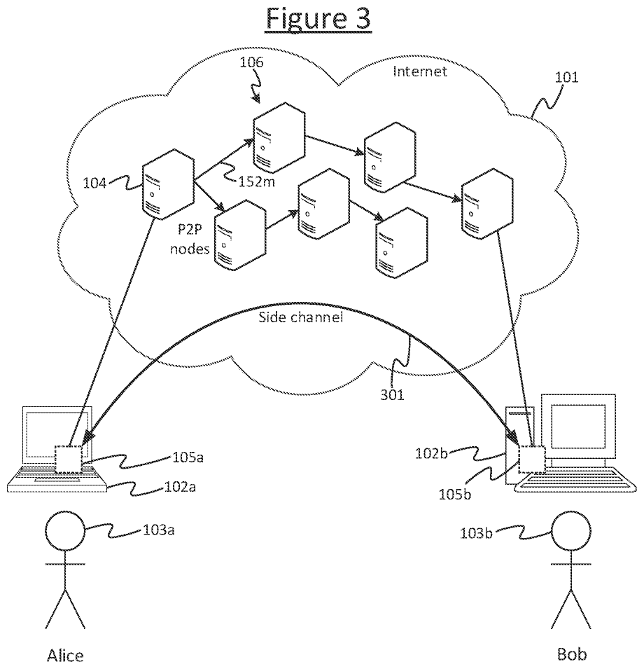

FIG. 3 shows a further system 100 for implementing a blockchain 150. The system 100 is substantially the same as that described in relation to FIG. 1 except that additional communication functionality is involved. The client application on each of Alice and Bob's computer equipment 102a, 120b, respectively, comprises additional communication functionality. That is, it enables Alice 103a to establish a separate side channel 301 with Bob 103b (at the instigation of either party or a third party). The side channel 301 enables exchange of data separately from the P2P network. Such communication is sometimes referred to as “off-chain”. For instance this may be used to exchange a transaction 152 between Alice and Bob without the transaction (yet) being published onto the network P2P 106 or making its way onto the chain 150, until one of the parties chooses to broadcast it to the network 106. Alternatively or additionally, the side channel 301 may be used to exchange any other transaction related data, such as keys, negotiated amounts or terms, data content, etc.

The side channel 301 may be established via the same packet-switched network 101 as the P2P overlay network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may comprise any one or more links via one or more networking technologies or communication media for exchanging data “off-chain”, i.e. separately from the P2P overlay network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

Client Software

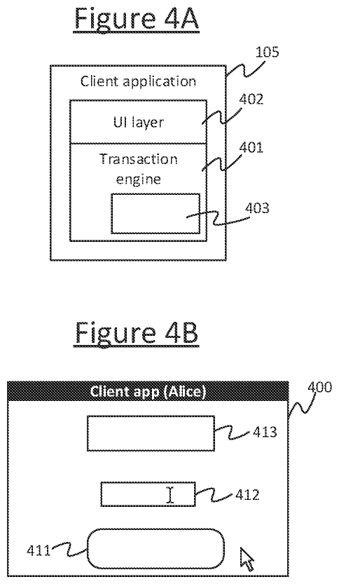

FIG. 4A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to be propagated through the P2P network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 4B gives a mock-up of an example of the user interface (UI) 400 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 4B shows the UI 400 from Alice's perspective. The UI 400 may comprise one or more UI elements 411, 412, 413 rendered as distinct UI elements via the user output means.

For example, the UI elements may comprise one or more user-selectable elements 411 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to generate transactions and send them to another user (Bob), and to generate a signature of a transaction in accordance with the described embodiments.

Alternatively or additionally, the UI elements may comprise one or more data entry fields 412, through which the user can input data to be included in the generated transaction and/or a message to be signed. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 413 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 400 shown in FIG. 4B is only a schematized mock-up and in practice it may comprise one or more further UI elements, which for conciseness are not illustrated.

### Preliminaries/Terminology

Coin Serial Number

A coin serial number is defined as a unique identifier of an issued digital coin (e.g. similar to serial numbers on bank notes). The coin serial number is represented by an integer that is calculated by a user using a pseudorandom function such that the probability of two equivalent serial numbers being generated is minimal.

Blinded Coin

A coin is blinded if the serial number of the coin is infeasible to calculate by someone who does not know the input to the computation that blinds the coin.

Coin Unblinding

A blinded coin can be unblinded by applying the inverse of the blinding function to the blinded serial number of the coin.

Blind Signature

A blind signature is one where the signer does not know the message they are signing, i.e. they sign a ‘blinded message’. The result is that a blind signature is still valid on the corresponding unblinded message.

Double-Spend Value

This value can identify a user Alice if and only if she double-spends a coin. That is, if Alice acts honestly, there is no computationally feasible way to identify her. On the other hand, if she double-spends a single coin, the double-spending equation can be used to identify her. Practically, this means that if she double-spends, it is possible to calculate her identity from information that is revealed in each spending of the coin. The information that is revealed could be her bank account number, public key, or other value corresponding to her identity. The following example is given for context. In an example system, a double-spender's bank account number u is revealed in the case of double-spending. The receiver of the coin (for example, a merchant) obtains some preimages of a hash function, which is used to calculate the serial number of the coin. The preimages given to the bank will be either

a, or a⊕(u∥J+i),

where a is some constant chosen by Alice at the point of withdrawal, u is Alice's account number, with bit length lᵤ, J is the start balance of her account, and i is the counter on the number of coins she spends. Note that ⊕ is the XOR operation, and ∥ is concatenation. If Alice double-spends, the bank will have knowledge of both these values which are referred to as “double-spending equations”, or “double-spend values”, the two terms being used interchangeably. So, once the bank has these values, they can remove the a in the second equation to find Alice's account number. This is done by applying the first value to the second value using the inverse operation of XOR, which is simply XOR again

a⊕(a⊕(u∥J+i))=(u∥J+i),

from which the bank has Alice's account number by reading the first Iᵤ bits of the result, and therefore the bank knows her identity. Note that if she doesn't double-spend, the bank will only know one of the above values, and so her identity cannot be derived.

Safe Prime

A safe prime is a prime number p which can be written as p=2p′+1, where p′ is also a prime.

RSA Modulus

An RSA modulus n is defined as n=p₁·p₂ where p₁ and p₂ are prime numbers.

Special RSA Modulus

An RSA modulus n=p₁·p₂ is called ‘special’ if p₁=2p′₁+1 and p₂=2p′₂+1 are safe primes.

Quadratic Residue

Given a group [symbol] ₙ, if there exist the elements a, b∈ [symbol] such that b²≡a mod n, then a is called a quadratic residue modulo n. We call the set of these quadratic residues QRₙ∈ [symbol] ₙ. If n is an RSA modulus, it is computationally difficult to calculate b given b²≡a mod n without knowing the factorisation of n. Note that, if n is an RSA modulus, the probability of a randomly chosen element being a quadratic residue is exactly ¼.

Generator

Given a group G of order n, an element g E G of the group is a generator if repeated application of itself using the group operation results in the group itself G. This is denoted by G= [symbol] g [symbol] where g is a generator. A group that can be generated in this way is called ‘cyclic’.

The following introduces two groups which are cyclic groups and will be relevant throughout the following sections.

The first group is denoted by G, and is generated by the element g which has prime order q. It can be assumed that the Decisional Diffie-Hellman problem is hard, meaning that it is hard to calculate u given g^{u}. This group is used in the derivation of public and private key pairs in several of the example schemes and is also used in the Dodis-Yampolskiy (DY) pseudorandom function that will be described below. The DY function can be used to calculate coin serial numbers and double-spending equations.

The second group is denoted by [symbol] which is generated by the element [symbol] and has prime order q′. This element is a quadratic residue modulo n, where n=p₁p₂ is a special RSA modulus. The generic element of the group [symbol] is denoted by [symbol] ∈ [symbol] . This group can be used to commit secrets, using Pedersen Commitment, and may be used in the signature scheme used by the bank.

Pedersen Commitment

Given [symbol] ᵢ, [symbol] ∈ [symbol] , where [symbol] ᵢ is a quadratic residue modulo n and is a generator of [symbol] of order q′, then the Pedersen commitment of the positive integers x₁, . . . xₘ∈[0, n) is defined to be

$$PedCom ( {x}_{1} , … , {x}_{m} ) = {\prod }_{i = 1}^{m}$$

where r is a randomly generated integer. Note that r and xᵢ are restricted to be less than the order of the group.

Camenisch-Lysyanskaya (CL) Signatures

It can be assumed that a user would like a signature by a third party on l messages without sharing the explicit value of the message. A list of messages can be labelled by (x₁, . . . , xᵢ)∈(0, min(n, n′)), where min(n, n′) is the minimum value of n and n′, which are the orders of groups [symbol] and [symbol] ′, respectively. The signer of the message has a public key (n, a₁, . . . , aₗ, b, c) where l is the length of the block of messages to be signed and a₁, . . . , aₗ, b, c∈ [symbol] ₙ are generators of [symbol] , where n is a special RSA modulus, and the signer's private key is p₁, implying that only they know the factorisation of n=p₁·p₂. Additionally, it can be assumed that [symbol] ₁, . . . , [symbol] ₗ, [symbol] ∈ [symbol] ′ where [symbol] ₁, . . . , [symbol] ₗ∈ [symbol] _{n′} and n′ is some integer.

To obtain a CL signature on the Pedersen-committed values (x₁, . . . , xₗ), the following steps are carried out.

1. The user calculates the Pedersen commitments \hat{V}=a₁^{X}^{₁} . . . aₗ^{x}^{ₗ}b^{\hat{r}} mod n and A=g₁^{x}^{₁} . . . gₗ^{x}^{ₗ}h^{r′} mod n′ where \hat{r} and r′ are randomly generated integers.

2. The user proves to the signer that they know the values (x₁, . . . , xₗ), that both \hat{V} and A are commitments to the same values x₁, . . . , xₗ, and finally that they are in the correct range.

3. The signer chooses a random integers and a prime number q, and computes V=(\hat{V}b^{ŝ}c)^{1/q} mod n.

4. The signer then sends (V, ŝ, q) to the user.

5. Let r=\hat{r}+ŝ, then the signature on the message (x₁, . . . , xₗ) is (V, r, q).

The key feature of this signature is that only the signer can efficiently calculate the q^{th} root of an element modulo n=p₁p₂, as only they know the factorisation.

DY Pseudorandom Function

A pseudorandom function is a function where the output is deterministic but appears to be random. In Y. Dodis and A. Yampolskiy, “A verifiable random function with short proofs and keys,” in International Workshop on Public Key Cryptography, 2005, Dodis and Yampolskiy defined a pseudorandom function which can be utilised in various of the example systems described below. Given a generator g E G with prime order p and a seed s, Dodis and Yampolskiy defined a pseudorandom function to be

$${F}_{g , s}^{DY} ( x ) = {g}^{{( s + x + 1 )}^{- 1} mod p} .$$

This function shall be referred to as a DY pseudorandom function.

Zero-Knowledge Proof of Knowledge

The general idea is that a prover provides enough information to a verifier to prove that they know a value, without revealing the value explicitly. There are various predefined ways to do this, depending on what one would like to prove. Note that most of the time, the verifier needs to provide input in the form of a challenge, otherwise a verifier could simply relay the same proof to another party, pretending they know the hidden value. There are cases of non-interactive proofs of knowledge, where the challenge is simply pre-agreed, or has a standard format, for example, the hash of the identity of the verifier, plus a time and date stamp.

The following examples provides a proof that an integer is in a certain range. This may be used to prove that the counter of the wallet is still within the value of the amount that was withdrawn. The aim of this proof will be to prove that Alice knows a counter value J, which has each bit value as either 0 or 1, and that Alice can prove which value it is, without sharing the value.

Proof of Knowledge of 1-of-2 Secrets

Assume Alice wants to prove that she knows 1-of-2 values. Let A∈Γ denote the set of indices i for which Alice knows a witness for the value xᵢ, where F is the sets of possible sets that can be used to reconstruct a secret. In the following example, i=1, 2. For each i∈Ā, where Ā is the complement of A, Alice runs simulator S with input xᵢ to produce conversations (m₁ⁱ, cᵢ, m₂ⁱ). These conversations are three rounds in a zero-knowledge proof of knowledge protocol, where cᵢ is the challenge sent by Bob, and m₂ⁱ is Alice's response. Then for each i∈A, Alice determines m₁ⁱ to be what she would send to Bob to prove knowledge, given a witness for input xᵢ. Alice sends the values m₁ⁱ for i=1, 2 to Bob.

1. Bob chooses a l-bit string str at random and sends it to Alice.

2. Consider the set of shares {share(cᵢ)|i∈Ā} that correspond to the challenges cᵢ from step 1. Ā is non-qualified in Γ*, meaning that Bob cannot reconstruct Alice's secret, given the values of cᵢ corresponding to Ā. Therefore, Alice can complete these shares to a full set of shares consistent with the string str without the risk of Bob being able to calculate the secret. Alice forms challenges cᵢ for indices i∈A such that share(cᵢ) equals the share produced in the completion process. This is done by copying the bits of the shares and padding with random bits if necessary. In step 1, S has produced a final message m₂ⁱ for m₁ⁱ and cᵢ by running the prover's algorithm. Finally, Alice sends the set of messages cₗ, m₂ⁱ for i=1, 2 to Bob.

3. Bob checks all conversations (m₁ⁱ, cᵢ, m₂ⁱ) would lead to acceptance by a verifier in the corresponding zero knowledge proof protocol as described in step 1, and also that the shares share(cᵢ) are consistent with the string s. He accepts if and only if these checks are satisfied.

This proof of knowledge is used in the following proof.

Prove that a Committed Integer I is in a Range [0, 2^{l}−1]

Let p be a large prime number, and q|p−1. Then g, h∈Zₚ* are elements of order q such that the discrete logarithm of h in base g is unknown.

1. Alice commits the integer/using the Pedersen Commitment scheme edCom(J; r)=h^{r}g^{J}.

2. She rewrites J as a binary representation such that J=J₀2⁰+J₁2¹+ . . . J^{t-1}2^{l-1}. Then Alice calculates the Pedersen Commitment for these Jᵢ, i=0, . . . l−1 with PedCom(Jᵢ;rⁱ) with r=Σᵢ₌₀^{k-1}rᵢ.

3. She proves that the number hidden by PedCom(xᵢ;rᵢ) is either 0 or 1 by proving that she knows either a discrete logarithm of PedCom(Jᵢ;rᵢ) in base h or PedCom(Jᵢ;rᵢ)/g in base h. This is done by proof of knowledge of a discrete logarithm as described below and a proof of knowledge of one out of two secrets as described above.

4. Bob finally checks that Πᵢ PedCom(Jᵢ;rᵢ)=PedCom(J; r).

If these checks verify, then the proof holds.

Turning a Proof of Knowledge of Secrets into One Signature of Knowledge on a Message m

Begin by assuming that Alice would like to turn a proof of knowledge of secrets into a signature of knowledge, such that Bob can verify it. In the following, ƒ is a pseudo-random function that turns an arbitrary length string into a range [0, n), where n is an RSA modulus. To sign a message m, Alice does the following steps.

1. Alice picks random numbers r₁, . . . r^{τ}∈[0, n) and computes xᵢ=rᵢ² mod n.

2. Alice computes ƒ(m, x₁, . . . , x_{τ}), takes the first kτ-bits and labels them as e_{i,j}, where 1≤i≤τ, 1≤j≤k. This creates a matrix of values e_{i,j}.

3. Alice computes vⱼ=ƒ(ID_{A}, j), for j=1, . . . , k, and where ID_{A} is identity of Alice.

4. She then computes sᵢ²=vᵢ⁻¹.

5. Next, she calculates yᵢ=rᵢΠₑ_{ᵢⱼ}₌₁ sⱼ mod n, for i=1, . . . , τ.

6. Finally, she sends ID_{A}, m, eᵢⱼ and yᵢ to Bob.

Bob verifies the signature in the following way.

1. Bob computes vⱼ=ƒ(ID_{A}, j) for j=1, . . . , k.

2. Bob computes zᵢ=yᵢ²Πₑ_{ᵢⱼ}₌₁ vⱼ mod n, for i=1, . . . , τ.

3. Bob verifies that the first kτ-bits of ƒ(m, z₁, . . . z_{τ}) are eᵢⱼ.

If this holds, then the signature is correct.

Zero-Knowledge Proof of Knowledge of a Discrete Logarithm

To prove knowledge of u in g^{u} whilst keeping u secret, the following protocol can be followed. Assume that g, h∈G are publicly known elements of G. If Alice would like to prove to Bob that she knows the right u to calculate g^{u}, she does the following.

1. Alice computes:

V=g^{u}h^{r}^{₁},

U=g^{r}^{₂}h^{r}^{₃},

where r₁, r₂, and r₃ are randomly generated secret integers and sends V and U to the Bob.

2. Bob chooses a challenge e, for example, e=hash(x), where x is some randomly chosen message, and sends this challenge e to Alice.

3. Alice is then required to calculate

l=r₂+eu,

m=r₃+er₁,

and return these to Bob.

4. Bob then verifies that

g^{l}h^{m}=UV^{e}.

If Bob finds this equation holds, then he knows that Alice knows the value of u.

Electronic Cash System

Electronic cash (ecash) was first introduced by Chaum in 1983. This was a very simple system in which a user could withdraw a blinded coin from an issuer, spend the unblinded coin with a merchant, and the merchant could deposit it with the issuer, with no link to the withdrawal. Since then, there have been many ecash systems proposed which improve on some aspect of this system, whether that is double-spending prevention leading to offline ecash, divisibility of a coin, batch spending coins, coin storage efficiency, recovering lost coins, or other improvements. In all ecash systems, an issuer provides a database service, storing previously spent coins to check for double-spending. Chaum's ecash was an online ecash, meaning that the issuer of the coins is required to be online at the time of spending the coin. This is because in order to accept a coin, a receiver of a coin must contact the issuer to check their database whether it has not already been spent. Offline ecash systems have some way to derive the identity of a double-spender at a later time, and so depositing the coin can be done when convenient. Note that in the following, the issuer of coins is referred to as the bank, but in general this could be any trusted third party.

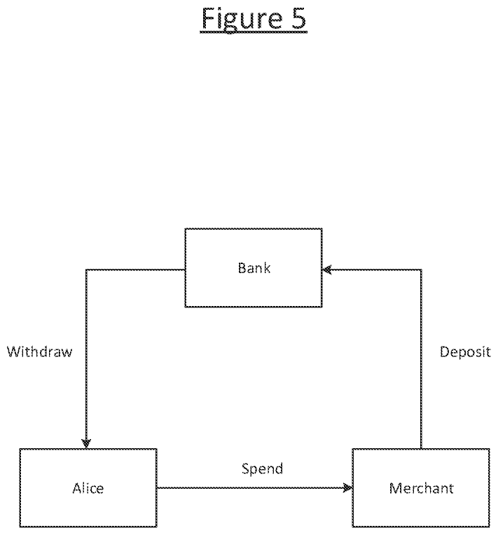

All ecash systems contain the same basic protocols: setup, withdraw, spend, and deposit. In the following examples, Alice wants to withdraw some ecash (digital coins) from the bank, and spend them with a merchant, who will then deposit them at the bank. This is shown in FIG. 5.

Setup

In all ecash systems, there is an initial setup, where Alice and the merchant in the scheme register their identity. This may involve either setting up an account with the bank or setting up a public-private key pair and sharing the public key. Similarly, in all ecash systems the bank must create their own public-private key pair and publish the public key.

Withdraw

In this step, Alice requests a wallet from the bank containing a certain value of coins. Alice initiates the wallet issuance by providing the bank with blinded coin serial numbers, or a wallet seed from which she derives the serial numbers. The bank then signs these blinded values, such that Alice can prove to a merchant that she obtained the wallet correctly. The protocol for obtaining a signature on the wallet may involve Alice sending blinded coin serial numbers to the bank, who then signs them, and returns the signature to Alice. Each ecash will specify which signature scheme to use. Alice then stores this signature as part of the wallet. The format of the wallet will depend on the specific ecash system, but in general, this is a set of values corresponding to the serial numbers of the coins, a signature on the coins by the bank, and in the case of offline cash, some extra information which will allow for the tracing of a double-spender. At this point, only Alice has knowledge of the coin serial numbers and so only she can spend them.

Spend

In order to spend a coin, Alice provides the merchant with the serial number of the coin, the signature by the bank, and if the protocol includes it, a double-spending equation. Alice must prove to the merchant that the serial number, signature, and double-spend equation (if present) all have the correct format. In simpler protocols, this can be done by directly checking the signature of the bank is correct, whilst in the more complicated cases, this involves a zero-knowledge proof of knowledge that the bank has signed some hidden values. The verification process will be described in more detail below for each protocol. If the coin is verified, the merchant accepts the coin.

Deposit

In the case of online ecash, the merchant immediately contacts the bank to deposit the coin. Then the bank will check a database of spent coins to see if it has already been spent. If not, the bank accepts the coin and the merchant receives the value of the coin. If it has been spent already, the merchant refuses the payment. In offline ecash, the merchant can deposit the coin with the bank whenever they require, such as at the end of the business day. The bank will then store the serial number, and some double-spend information. If it is the case that the coin is a double-spend, then the culprit can be identified using this extra double-spend information. In some protocols, it is also possible to calculate the remaining unspent coins after a double-spend, and so these can be blacklisted.

Digital Coin System

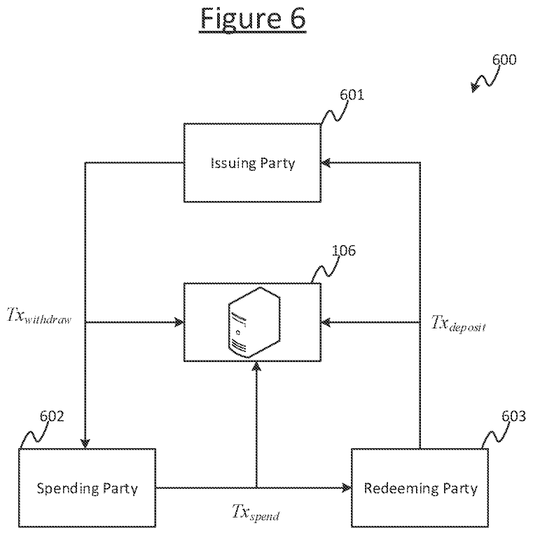

FIG. 6 illustrates an example system 600 for implementing a digital cash system for issuing digital coins. The system 600 comprises an issuing party 601 (e.g. a bank or other trusted third party) responsible for issuing digital coins to a spending party 602 (e.g. an end user Alice 103a, or a business, service, university, charity, etc.). The system also comprises a redeeming party 603 (e.g. a merchant) who, upon receiving a digital coin from the spending party 602, can deposit the digital coin with the issuing party 601 and in return, receive a digital asset represented by the digital coin. For example, the spending party 602 may provide the redeeming party 603 with a digital coin in return for a service offered by the redeeming party, and then the redeeming party can then redeem the digital coin with the issuing party for an amount of traditional money (i.e. fiat currency) represented by the digital coin. The system 600 further comprises the blockchain network 106. Each of the issuing party 601, spending party 602 and redeeming party 603 are configured to interact, directly or indirectly, with the blockchain 150, e.g. to transmit transactions to the blockchain 150, to obtain transaction from the blockchain 150, etc.

Note that each of the issuing party 601, spending party 602, and the redeeming party 603 may perform some or all of the functions attributed to Alice 103a and Bob 103b with references to FIGS. 1 to 4.

As shown in FIG. 6, the issuing party 601 may be configured to transmit a withdrawal transaction Tx_{withdraw} to the spending party 602, e.g. over a side channel 301. The withdrawal transaction Tx_{withdraw} may also be sent to the blockchain network 106. The spending party 602 may be configured to transmit a spending transaction Tx_{spend} to the redeeming party 603, e.g. over a side channel 301. The spending transaction Tx_{spend} may also be sent to the blockchain network 106. The redeeming party 603 may be configured to transmit a deposit transaction Tx_{deposit} to the issuing party 601, e.g. over a side channel 301. The deposit transaction Tx_{deposit} may also be sent to the blockchain network 106. Note that this is just one illustrate example for the flow of transactions between the parties. Other flows are possible and will be discussed below.

For brevity, embodiments of the present invention will be described in relation to a bank (issuing party 601), a customer called Alice (spending party 602), and a merchant (redeeming party 603). However it will be appreciated that these are merely convenient labels for the parties involved and are not intended to be limiting.

Setup

The bank 601 and Alice 602 are configured to interact as part of a setup protocol. Alice 602 registers an identifier with the bank 601. The identifier may be a bank account number, a passport number, a driving license, a name and address, etc. In some examples, the identifier may be a public key, e.g. of a public-private key pair. Alice 602 may register her identifier as part of a know-your-customer (KYC) process. Alice 602, the bank 601 and the merchant 603 each have a public key suitable for use as part of the blockchain protocol, e.g. an elliptic curve public key. That is, a public key that can be linked to a signature for use in signing blockchain transactions. Each public key may also form the basis of a respective address for use on the blockchain 150. In the examples below, Alice 602 has public key P_{A} and corresponding private key sk_{A}, the bank 602 has public key P_{B} and corresponding private key sk_{B}, and the merchant 603 has public key P_{M} and corresponding private key sk_{M}. Each party's public key may be known to each. Alternatively, in some examples, Alice's public key P_{A} may not be known to the other parties, at least initially. Furthermore, unless the context requires, reference to a party's public key may be taken to any public key to which that party owns the private key. In other words, Alice 602 may use one public key to sign a transaction and another public key as the basis of a blockchain address. For instance, Alice 602 may use two different public keys as part of the protocol, one of which is the known public key P_{A}, and one of which is derived from that known public key, e.g. P_{A}′.

The merchant 603 may undergo a similar process to Alice 602 to register an identifier of the merchant 603.

Withdraw

In order to withdraw one or more digital coins from the bank (i.e. in order for the bank 601 to issue Alice 602 with digital coins), Alice 602 and the bank 601 must undertake a coin seed signing protocol. The coin seed s is a value (i.e. a number) known only to Alice 602. That is, Alice 602 generates a coin seed s and does not share it with the bank 601 or with the merchant 603. The coin seed s may be generated by a pseudorandom number generator. Alice 602 sends the coin seed s to the bank 601 in the form of as a blinded message, such that the bank 601 cannot discern the coin seed. The bank 601 signs the blinded coin seed and returns the blind signature σ_{B} (i.e. a signature on the blinded coin seed) to Alice 602. The bank 601 may sign the blinded coin seed using the private key sk_{B} or alternatively with a different signing key.

In some examples, the coin seed s may be based on an input from the bank 601. That is, the bank 601 provides Alice 602 with an input r′. The coin seed is then generated based on an input s′ from Alice and the input r′ from the bank, e.g. s=s′+r′.

Alice 602 uses the coin seed to generate one or more coin serial numbers. Each coin serial number represents a single digital coin. Each digital represents a predefined amount of a digital asset, which may be set by the bank 601. For instance, each digital coin may represent £100 (this may be specified in an OP_RETURN output, or alternatively it may be a predetermined convention or protocol that all coins always represent £100). Alice 602 and the bank 601 may agree that Alice can generate a set number of coin serial numbers. The bank 601 may then debit Alice's bank account based an amount equal to the set number of coin serial numbers.

Alice 602 generates a first one of the coin serial numbers (and in some examples, the only coin serial number) based on the coin seed. The first coin serial number may be generated by applying a pseudorandom function to the coin seed, e.g. the DY pseudorandom function. The first coin serial number is therefore linked to the coin seed but appears to be a random value.

Now, a withdrawal transaction, which is a blockchain transaction, is generated which acts as evidence of the withdrawal of a digital coin, i.e. the digital coin corresponding to the first serial number. The party that generates the withdrawal transaction depends on whether the digital coin system is a traceable coin system or an untraceable coin system.

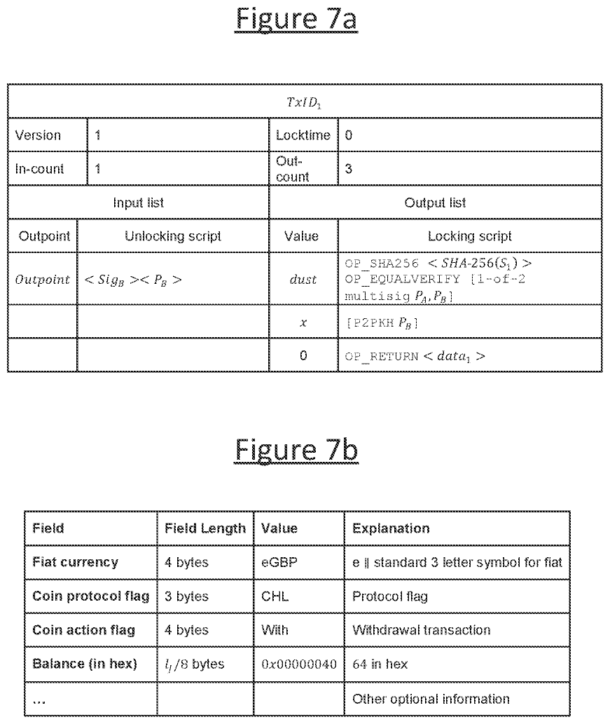

For a traceable coin system, the withdrawal transaction comprises a signature Sig_{B} of the bank. That is, the withdrawal transaction is signed by the bank 601. An example traceable withdrawal transaction is illustrated in FIG. 7a. The bank's signature Sig_{B} is included in an input of the withdrawal transaction (along with the bank's corresponding public key P_{B} in this example).

The withdrawal transaction also comprises a first output that includes a hash of the first coin serial number. Note that other alternative one-way functions may be used instead of a hash function. The first output comprises an output script that is configured to, when executed alongside an input of a spending transaction, require the input of the later transaction to include a pre-image of the hash function (i.e. the first coin serial number itself) in order to unlock the first output. Optionally, as shown in the example of FIG. 7a, the output script may also be locked to the public key P_{A} of Alice and/or the public key P_{B} of the bank 601. For example, the first output may be a multi-signature output. That is, in order to unlock the first output, the spending input must comprise a signature Sig_{A} corresponding to Alice's public key P_{A} and/or a signature Sig_{B} corresponding to the bank's public key P_{g}. A second output may be included which returns change to the bank 601.

In the example of FIG. 7a, the withdrawal transaction comprises first data representing the first digital coin. The first data may be included in a spendable output, or in an unspendable output (e.g. an OP_RETURN output). An example of the first data is shown in FIG. 7b. The first data may comprise one, some or all of: a prefix denoting the digital asset represented by the digital coin (e.g. a currency), a coin protocol flag, a coin action flag (e.g. withdrawal), and a balance of the digital coin.

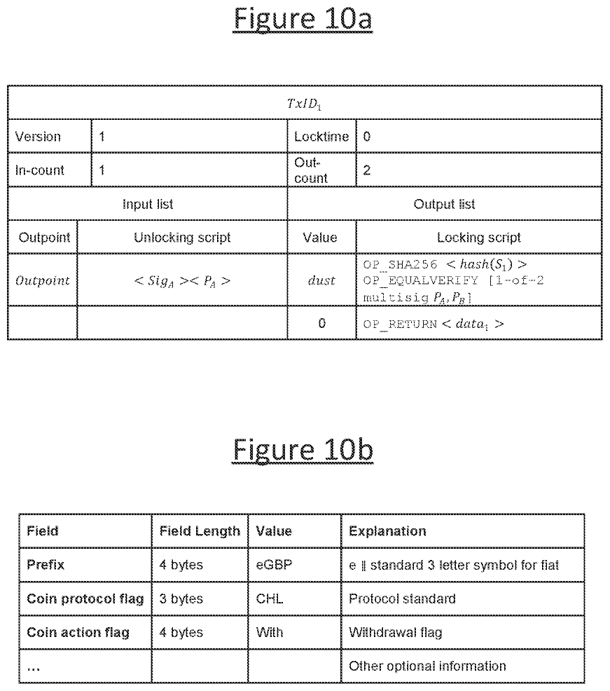

For an untraceable coin system, the withdrawal transaction comprises a signature Sig_{A} of Alice. That is, the withdrawal transaction is signed by Alice 602. An example untraceable withdrawal transaction is illustrated in FIG. 10a. Alice's signature Sig_{A} is included in an input of the withdrawal transaction (along with Alice's corresponding public key P_{A} in this example). The untraceable withdrawal transaction comprises the same first output described above in relation to the traceable withdrawal transaction. The untraceable withdrawal transaction may also comprise first data representing the first digital coin, as described above. An example of the first data is shown in FIG. 10b.

In the case where the bank signs the withdrawal transaction, Alice 602 sends the hash of the first coin serial number to the bank 601 for it to be included in the first output. Alternatively, Alice 602 may generate a transaction template which comprises at least the first output, and then the bank 601 may add the input, and one or more of the outputs if required. The bank 601 may then submit the withdrawal transaction to the blockchain network. The bank 601 may also send a copy of the withdrawal transaction to Alice 602.

In the case where Alice 602 signs the withdrawal transaction, Alice 602 does not need to send the withdrawal transaction to the bank 601. Alice 602 need only submit the withdrawal transaction to the blockchain network.

Optionally, the withdrawal transaction may comprise more than one output that comprises a hash of a coin serial number. For example, Alice 602 may generate a second coin serial number to represent a second digital coin. The first coin serial number may be the seed of the second serial number (i.e. the second coin serial number may be generated be applying the pseudorandom number function to the first coin serial number), or the second coin serial number may be generated be applying the pseudorandom number function directly to the coin seed. In these examples, the withdrawal transaction comprises a series of outputs which are similar to the first output except that the hash value is different. Each output may be associated with a respective data output, i.e. an output having data similar to the first data.

Spending

To spend the first digital coin in a transaction (e.g. a trade) with the merchant 603, Alice 602 provides the merchant 603 with the first coin serial number. The merchant 603 checks whether the first coin serial number is included in a transaction of the blockchain. Note that only the hash of the first coin serial number is included in the withdrawal transaction, not the first coin serial number itself. If the first coin serial number is included on the blockchain, the merchant 603 rejects the first digital coin and terminates the transaction. The first coin serial number may be included on the blockchain as part of a spending on the first digital coin by Alice 602, or as part of blacklisting the first digital coin by the Bank 601, as discussed below. If the first coin serial number is not included on the blockchain, the merchant 603 may decide to accept the digital coin and proceed with the transaction.

The merchant 603 obtains a spending transaction in response to one or more conditions being met. The one or more conditions include a condition that the first coin serial number is not present on the blockchain. The spending transaction comprises the first coin serial number and acts as evidence that the merchant 603 has accepted the digital coin represented by the first coin serial number. The merchant 603 may generate the spending transaction in full or in part, e.g. in combination with Alice 602. That is, one, some or all of the inputs and/or outputs of the spending transaction may be generated by the merchant 603. Similarly, one, some or all of the inputs and/or outputs of the spending transaction may be generated by Alice 602.

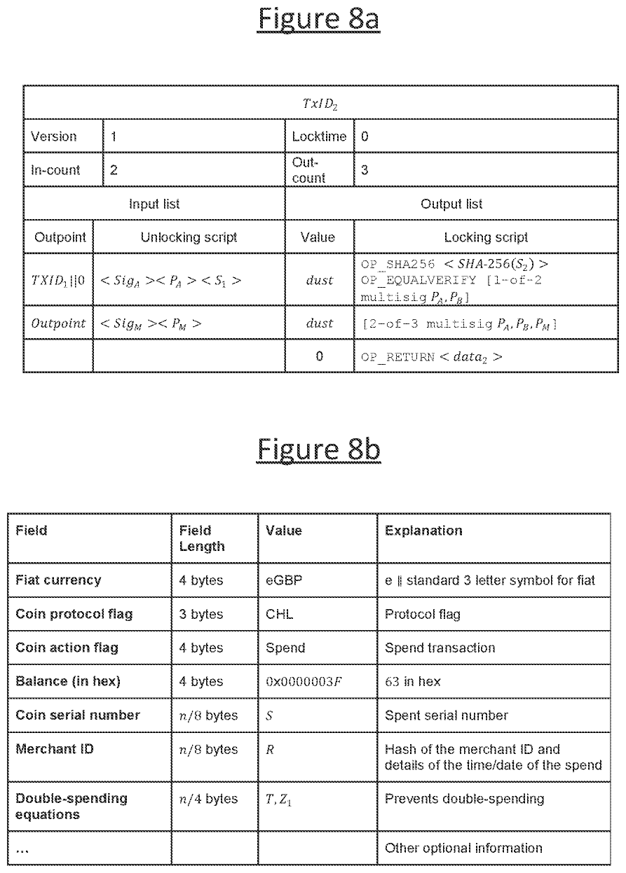

FIG. 8a illustrates an example of a traceable spending transaction. The traceable spending transaction comprises the first coin serial number, thus revealing the first coin serial number when the spending transaction is submitted to the blockchain network. In this example, the first coin serial number is included in a first input of the spending transaction. The first input of the spending transaction may reference the first output of the withdrawal transaction, thus creating a chain of transactions. If required by the first output of the withdrawal transaction, the first input may comprise Alice's signature Sig_{A} and/or public key P_{A}. The spending transaction may comprise a second output which comprises the merchant's signature Sig_{M} and/or public key P_{M}. The second output may reference a transaction output locked to the merchant's public key P_{M}.

If Alice 602 would like to later spend another one of her digital coins, the spending transaction may comprise a first output similar to the first output of the withdrawal transaction, except that the hash value is of a different one of her coin serial numbers. The first output of the spending transaction may be locked to Alice's and/or the bank's respective public keys.

The spending transaction may comprise a second output locked to respective public keys of Alice 602, the bank 601 and/or the merchant 603. Multi-signature outputs may be used to lock an output to a minimum of n public keys out of a total set of m public keys.

The spending transaction may comprise a third output comprising second data, e.g. in a spendable or unspendable output. FIG. 8b illustrates an example of the second data. In this example, the second data may include some or all of the items included in the first data of the withdrawal transaction discussed above. The second data may include the spent coin serial number (i.e. the first coin serial number) and the remaining balance of Alice's digital coins. The second data may include additional items which will be discussed below.

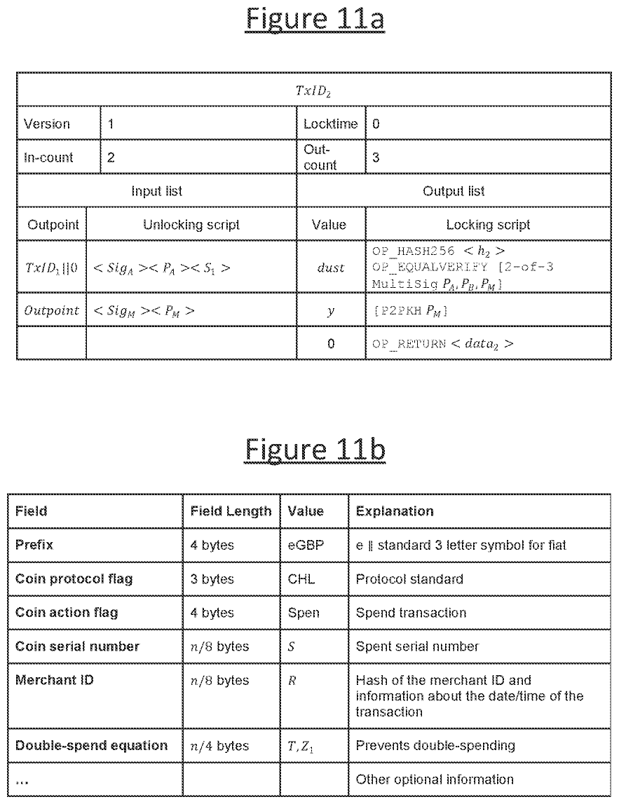

FIG. 11a illustrates an example of an untraceable spending transaction. Like the traceable spending transaction, the untraceable spending transaction comprises the first coin serial number. In this example, the first coin serial number is included in a first input of the spending transaction. The first input of the spending transaction may reference the first output of the withdrawal transaction, thus creating a chain of transactions. If required by the first output of the withdrawal transaction, the first input may comprise Alice's signature Sig_{A} and/or public key P_{A}. The spending transaction may comprise a second output which comprises the merchant's signature Sig_{M} and/or public key P_{M}. The second output may reference a transaction output locked to the merchant's public key P_{M}.

The untraceable spending transaction may comprise a first output that comprise a hash of second data representing the spent digital coin. This output may be signed by Alice, which acts as evidence that Alice 602 has attested to the spending of the digital coin. The second data itself may be included in a different output of the transaction (the third output in FIG. 11a). The first output may be configured to require an input of a later transaction to include the second data itself. A second output of the spending transaction may be locked to respective public keys of Alice 602, the bank 601 and/or the merchant 603.

The second data may be included in a spendable or unspendable output. FIG. 11b illustrates an example of the second data. Like in the example of FIG. 8b, the second data may include some or all of the items included in the first data of the withdrawal transaction discussed above. The second data may include the spent coin serial number (i.e. the first coin serial number).

The merchant 603 may sign the (traceable or untraceable) spending transaction once Alice 602 has added her input (i.e. the input comprising her signature Sig_{A}) and the outputs of the transaction. The merchant 603 may then submit the spending transaction to the blockchain network, or send the spending transaction to Alice 602 for her to submit it to the blockchain network. As another example, the merchant 603 may submit the spending transaction to a third party, which may be a service provider such as a wallet provider.

Optionally, Alice 602 may provide the merchant 603 with the withdrawal transaction, or the merchant may obtain the withdrawal transaction from the blockchain, e.g. using a transaction identifier TxID provided by Alice 602. The merchant 603 may check that the first input of the spending transaction unlocks the first output of the withdrawal transaction, or at least references the first output of the withdrawal transaction.

Deposit

Once the one or more conditions imposed by the merchant 603 have been met and the merchant has decided to accept the digital coin, e.g. as payment for goods or services, the merchant contacts the bank 601 to deposit the digital coin and redeem the amount of the asset represented by the digital coin.

The merchant 603 sends the first coin serial number to the bank 601. The merchant 603 may send the first coin serial number directly to the bank 601. Additionally or alternatively, the merchant 603 may provide the bank 601 with the spending transaction that includes the first coin serial, or at least a transaction identifier TxID of the spending transaction. As another option, the bank 601 may obtain the spending transaction directly from the blockchain upon being alerted to a transaction which is locked to its public key P_{B}.

The bank 601 checks whether the first coin serial number is present in a record of spent coin serial numbers maintained by the bank 601. The coin serial numbers may be maintained on the blockchain 150, i.e. recording the serial numbers in transactions on-chain, or in a separate database. If stored in a database, the blockchain 150 may be scanned for serial numbers, e.g. when a coin flag appears on-chain. The database may also be stored on the blockchain 150. If the first coin serial number is present in the database, the digital coin represented by the first coin serial number has already been spent and thus the deposit of the digital coin by the merchant 603 will be rejected. If the first coin serial number is not present in the database, the bank 601 may accept the digital coin and transfer, to the merchant 603, the amount of the asset represented by the digital coin. One or more further conditions may have to be met in order for the bank 601 to transfer the amount of the asset to the merchant 603.

The merchant 603 obtains a deposit transaction. The merchant 603 may generate the deposit transaction in full, or in collaboration with the bank 601. The deposit transaction comprises an input that references an output of the spending transaction, e.g. the second output. The deposit transaction may comprises the merchant's signature Sig_{M} and/or the bank's signature Sig_{B}. The merchant 603 may generate the deposit transaction and submit it to the blockchain network, or the merchant 603 may generate the deposit transaction and transmit it to the bank 601 for the bank to submit it to the blockchain network, or even to a third party such as a wallet provider. Alternatively, the bank 601 may generate the deposit transaction and then submit it to the blockchain or to the merchant 603.

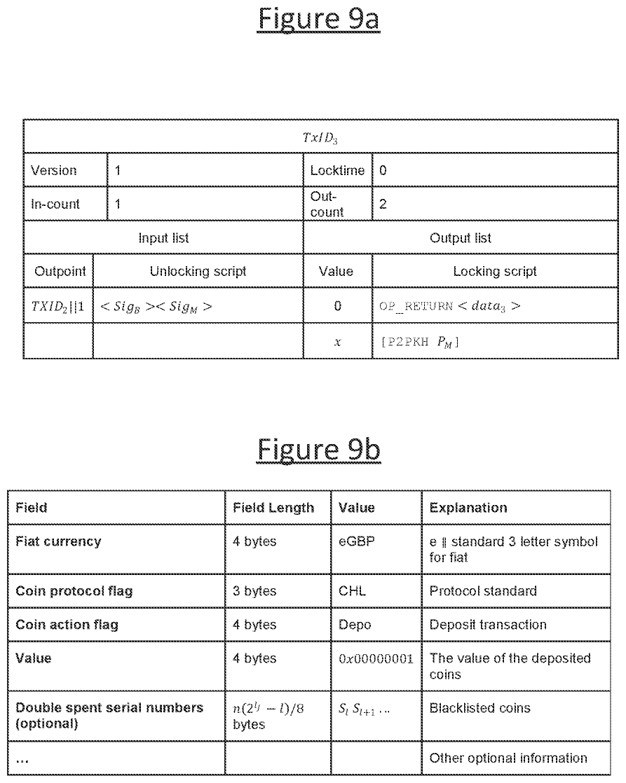

FIG. 9a illustrates an example of a traceable deposit transaction. In this example, a first input of the deposit transaction is signed by both the bank 601 and the merchant 603. That is, the first input includes the bank's signature Sig_{B} and the merchant's signature Sig_{M}. The first input references an output of the spending transaction. In this example, the first input references the second output of the spending transaction, i.e. the multi-signature output.

The deposit transaction may comprise third data. An example of the third data is shown in FIG. 9b. The third data may comprise one or more data fields in common with the first and/or second data. The third data may comprise an indication of the value of the deposited coin. If the deposit transaction is generated by the bank 601 upon discovering that Alice 602 has attempted to double-spend the digital coin, the third data may comprise the serial numbers of any remaining unspent digital coins issued to Alice 602.

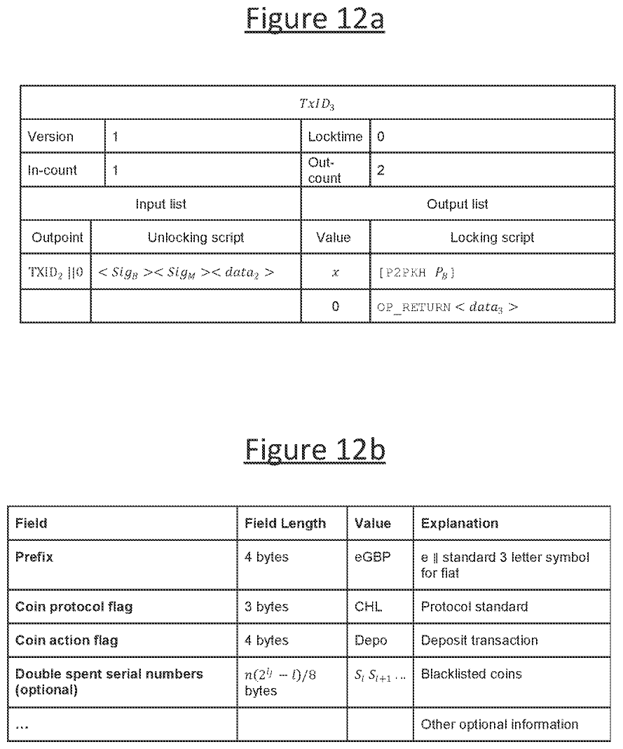

FIG. 12a illustrates an example of an untraceable deposit transaction. Similar to the example deposit transaction shown in FIG. 9a, a first input of the deposit transaction is signed by both the bank 601 and the merchant 603. The first input references an output of the spending transaction, e.g. the first output of the untraceable spending transaction. In this example, the first output of the untraceable spending transaction included a hash puzzle of the second data. In other words, the first output of the untraceable spending transaction comprised a script configured to require an input of a later transaction attempting to unlock the first output to comprise a pre-image in the form of the second data. Therefore the first output of the deposit transaction in this example comprises the second data in raw form.

The deposit transaction may comprise one or more outputs. As shown in FIG. 12a, the deposit transaction may comprise a first output locked to a public key P_{M} of the bank 601. The deposit transaction may comprise a second output comprises third data. FIG. 12b illustrates an example of the third data.

Other Optional Conditions

In some embodiments, one of the conditions that must be met in order for the bank 601 to accept the digital coin is that the spending transaction comprises an input that references and unlocks an output of the withdrawal transaction, e.g. the withdrawal transaction signed by the bank 601. Similarly, one of the conditions that must be met in order for the merchant 603 to accept the digital coin is that Alice 602 provides a withdrawal transaction, or a reference to a withdrawal transaction, that is signed by the bank 601.

In additional or alternative embodiments, one of the conditions that must be met in order for the bank 601 to accept the digital coin is that the spending transaction comprises an input that is signed by Alice 602 and/or the bank 601. In some examples, both signatures must be present.

In some embodiments, Alice 602 may transmit a coin seed proof to the merchant 603. A coin seed proof is a proof that Alice 602 has knowledge of the bank's blind signature σ_{B} of the coin seed. In some examples, the coin seed proof may simply be the blind signature itself. In other examples, the coin seed proof may be a zero knowledge proof. Zero knowledge proofs have been discussed above. The merchant 603 may determine, based on the coin seed proof, whether Alice 602 does indeed have knowledge of the bank's signature σ_{B} on the coin seed. One of the conditions for the merchant 603 accepting the digital coin may be that the coin seed proof proves that Alice 602 has knowledge of the signature σ_{B}.

In some embodiments, the merchant 603 may transmit the coin seed proof to the bank 601 when attempting to deposit the digital coin. Like the merchant 603, the bank 601 may determine, based on the coin seed proof, whether Alice 602, and therefore the merchant 603, does indeed have knowledge of the bank's signature σ_{B} on the coin seed. One of the conditions for the bank 601 accepting the digital coin may be that the coin seed proof proves that Alice 602 has knowledge of the signature σ_{B}.

In some embodiments, Alice 602 may generate one or more double-spend seeds. Each double-spend seed may be used to generate a double-spend value. Double-spend values have been described above. Alice 602 may transmit a blinded version of the one or more double-spend seeds to the bank 601, who returns a blind signature σ_{B} of the one or more double-spend seeds. The signature σ_{B} of the one or more double-spend seeds may be the same signature σ_{B} of the coin seed. That is, the bank 601 may sign the coin seed and double-spend seed(s) as a whole.

When spending a digital coin at the merchant 603, Alice 602 may use the respective double-spend seed(s) to generate one or more respective double-spend values. Alice 602 transmits the double-spend value(s) to the merchant 603, e.g. as part of the spending transaction. Each double-spend value is based on one of the double-spend seeds, an identifier of Alice 602 (e.g. her bank account number, public key, passport number, etc.), and a data item chosen by, and sent to Alice 602 by, the merchant 603. The data item varies with each interaction between Alice 602 and the merchant 603. For instance, the data item may be based on the time and/or date of the interaction, an invoice of the goods or services purchased by Alice 602, or any other variable. Each double-spend value generated by Alice 602 reveals a different component of Alice's identifier, due to the different data items. If Alice 602 attempts to double-spend the same coin, enough information about her identifier will be revealed for her to be identified by the bank 601.

When the merchant 603 deposits a digital coin, the merchant 603 transmits the double-spend value(s) to the bank 601. If the bank 601 finds that that the first coin serial number is present in the record (i.e. on the blockchain 150) of spent coin serial numbers, the bank 601 may use the double-spend value(s), together with the previously received double-spend value(s), i.e. those received when the first digital coin was first deposited, to reveal Alice's identity. If Alice 602 has any remaining unspent digital coins, the bank 601 may blacklist those coins. Examples of blacklisting coins will be discussed below.

Alice 602 may transmit a double-spend seed proof to the merchant 603. A double-spend seed proof is a proof that Alice 602 has knowledge of the bank's blind signature σ_{B} of the double-spend seed(s). In some examples, the double-spend seed proof may simply be the blind signature σ_{B} itself. In other examples, the double-spend seed proof may be a zero knowledge proof. Zero knowledge proofs have been discussed above. The merchant 603 may determine, based on the double-spend seed proof, whether Alice 602 does indeed have knowledge of the bank's signature σ_{B} on the double-spend seed. One of the conditions for the merchant 603 accepting the digital coin may be that the double-spend seed proof proves that Alice 602 has knowledge of the signature σ_{B}. In some embodiments, the merchant 603 may transmit the double-spend seed proof to the bank 601 when attempting to deposit the digital coin. Like the merchant 603, the bank 601 may determine, based on the double-spend seed proof, whether Alice 602, and therefore the merchant 603, does indeed have knowledge of the bank's signature σ_{B} on the double-spend seed. One of the conditions for the bank 601 accepting the digital coin may be that the double-spend seed proof proves that Alice 602 has knowledge of the signature σ_{B}.

In some embodiments, Alice 602 may generate a hash of the merchant's identifier R (e.g. comprising the public key P_{M}) and a data item chosen by the merchant 603. As discussed above, the data item may be based on the interaction between Alice 602 and the merchant 603, e.g. the date and/or time of the interaction. Alice 602 may transmit the hash of the merchant's identifier R to the merchant 603, e.g. as part of the spending transaction. One of the conditions for the merchant 603 accepting the digital coin may be that the merchant 603 agrees on the hash of the merchant's identifier R. When depositing the digital coin with the bank 601, the merchant 603 may transmit the hash of the merchant's identifier R to the bank 601. The bank 601 may maintain a record (either on of off-chain) of received merchant identifier hashes (i.e. respective hashes of the merchant's identifier). One of the conditions for the bank 601 accepting the digital coin may be that the most recently received merchant identifier hash does not appear in the record (e.g. on the blockchain 150). If the merchant identifier hash does appear in the database it means that the merchant is attempting to double-spend the digital coin.

Example Transactions

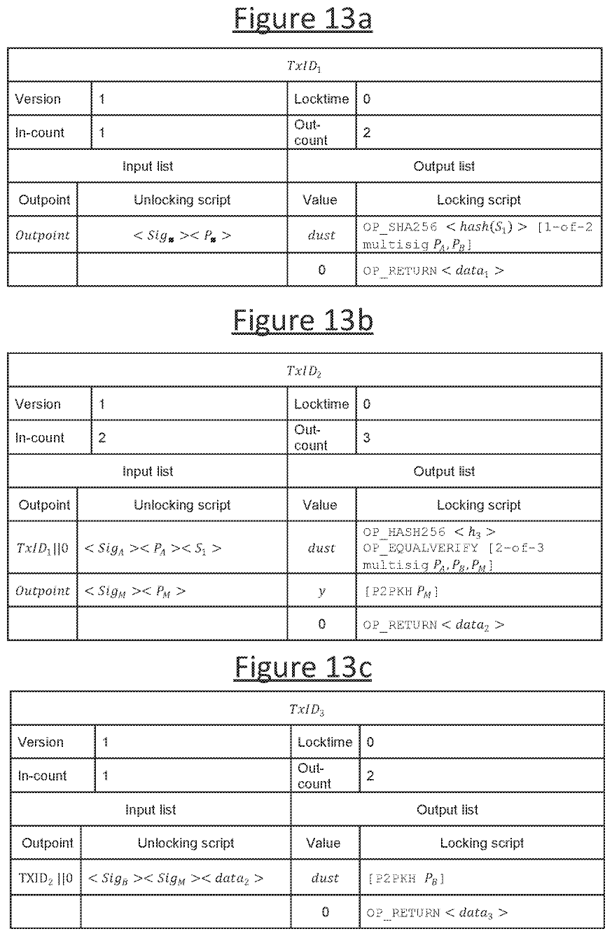

FIGS. 13a to 13c respectively illustrate example generic withdrawal, spending and deposit transactions which may be used in any digital cash protocol. These example transaction may be used for any protocol, with the only part of the transaction that changes being the OP_RETURN data.

FIG. 13a illustrates a generic withdrawal transaction. Alice 602 obtains a signature σ_{B} from the bank 601 on serial numbers of coins. The withdrawal transaction is created to signify that this interaction has taken place. The input in this transaction is from the bank 601 in a traceable protocol, or from Alice 602 in an untraceable protocol. The data will be specified for each digital coin system.

FIG. 13b illustrates a generic spending transaction. Alice 602 proves to a merchant 603 that she has a coin that has the correct format and a signature σ_{B} from the bank 601 on the coin. A spend transaction is created to signify her spend has been accepted by the merchant 603, where the input is from the withdrawal transaction. This transaction contains the serial number of the coin and additional information that can identify her if she double-spends. If there is another coin to be spent in the traceable case, there is an additional output which has the same format as the output in the withdrawal transaction, such that Alice 602 can spend the next coin. The data in the OP_RETURN shall be specified for each digital coin system.

FIG. 13c illustrates a generic deposit transaction. The merchant 603 provides the bank 601 with proof that they accepted the coin honestly. A deposit transaction is created, which spends the output of the spend transaction, signifying that the deposit has been accepted. This transaction is the same for both the traceable and untraceable protocol. The data in the OP_RETURN shall be specified for each digital coin system.

Example Protocols

Traceable Digital Coins

The following describes an example traceable protocol which utilizes the blockchain to prevent double-spending. In a traceable protocol, the digital coins are traceable due to the fact that each spending transaction is linked to the withdrawal transaction, which is signed by the bank 601. This link has the result that it is easier to prove that the coins were indeed issued by the bank 601.

Alice 602 would like to withdraw a wallet from the bank 601 and spend some of the digital coins with a merchant 603, who will then deposit the coin(s) with the bank 601. The bank 601 has a public/private key pair (pk_{B}, sk_{B}). In this protocol, the bank 601 can sign (i+3) messages at the same time. The bank's public key is then (n, a₁, . . . , aᵢ₊₃, b, c) and the private key is p₁ such that n=p₁p₂ is a special RSA modulus. The example protocol below uses i=1, but it is easy to modify the protocol for a larger i. This extension allows for additional secrets to be committed and then revealed in the event of double-spending. Additionally, Alice 602 and the merchant 603 each have their own unique key pair such that (pkᵤ, skᵤ)=(g^{u}, u) for some u∈ [symbol] _{q}, where q is prime, and g∈G as before. Finally, all users also have their own elliptic curve (EC) public/private key pair of the form (pk=sk·G, sk), such that they can receive and spend bitcoin. Alice's key pair is denoted (P_{A}, sk_{A}), the bank's key pair is given by (P_{B},sk_{B}), and finally, the merchant's key pair is (P_{M}, sk_{M}).

Alice contacts the bank 601 and asks the bank to withdraw a wallet W of value 2^{l}^{_{J}}, which contains a seed for coin serial numbers and double-spending equation. She sends the bank 601 the committed seeds (u, s, t), the bank 601 then signs this commitment, and returns this signature σ_{B}. The total value of the coins 2^{l}^{_{J}} is taken from her account.

In order to withdraw 2^{l}^{_{J}} coins, the following steps are taken. Note that in this protocol, Alice 602 can only withdraw a wallet containing 2^{l}^{_{J}} coins due to the nature of the zero-knowledge proof of knowledge of the value of the internal counter of the coins J, where lⱼ is the bitwise length of the counter.

Alice 602 identifies herself to the bank 601 by proving knowledge of skᵤ using the zero-knowledge proof described in the introduction. Alice 602 and the bank 601 now generate the wallet secrets in the following way. Alice 602 selects random values s′, t, \dot{r}∈ [symbol] ₘ and sends the Pedersen Commitment A′=PedCom(u, s′, t)= [symbol] ^{\dot{r}} [symbol] ₁^{u} [symbol] ₂^{s′} [symbol] ₃^{t}, to the bank 601. The bank 601 selects a random integer r′ to contribute to the wallet and sends this to Alice 602. Both the bank and Alice individually calculate A= [symbol] ₂^{r′} A=PedCom(skᵤ,s′+r′, t)=PedCom(skᵤ, s, t).

This step is essentially creating the wallet secrets, and having the bank 601 contribute randomness to this. Alice 602 and the bank 601 run the CL signature protocol for obtaining the bank's signature on the values in the Pedersen Commitment A, resulting in a signature σ_{B} (u, s, t)=(V, r, e), where V=(a₁^{u}a₂^{s}a₃^{t}b^{r}c)^{1/e}. The method for calculating this signature is given above in the preliminaries section, where (x₁, x₂, x₃) are (u, s, t).

Alice 602 saves the wallet W=(u, s, t, σ_{B}(u, s, t),J), where J is an l_{J}-bit counter initialised to zero. Note that the signature by the bank 601 is only on the wallet seeds s, t, such that serial numbers and the double-spending equations do not necessarily need to be stored in the wallet, and instead can be derived using the wallet seeds and the wallet counter when required. The bank 601 records a debit of 2^{l}^{_{J}} coins for the account corresponding to Alice 602.

The wallet has the form

W=(u,s,t,σ_{B}(u,s,t),J),

where
u is Alice's private key,
s is the seed of the coin serial numbers,
t is the seed of the double-spend equations,
σ_{B}(u, s, t) is the signature by the bank on these values, and
J is the counter of the wallet.

Furthermore, the wallet may include additional variables which will be used to reveal more secrets if Alice 602 double-spends. The additional variables are denoted (z₁, . . . , zₗ), where l is the number of additional secrets one would like to reveal. Note that l∈[0, n−3), where the CL signature scheme group is modulo n, and the range is up to n−3 as there are already 3 values to sign in Camenisch, Hohenberger, and Lysyanskaya (CHL) protocol described in J. Camenisch, S. Hohenberger and A. Lysyanskaya, “Compact e-cash,” in Annual International Conference on the Theory and Applications of Cryptographic Techniques, 2005 (see below for more details). The bank 601 signs these new variables with the other wallet secrets, such that the wallet is now

W=(u,s,t,(z₁, . . . ,zₗ),σ_{B}(u,s,t,(z₁, . . . ,zₗ)),J).

These additional wallet secrets can be used calculate l double-spending equations Z₁, . . . , Zₗ, in the exact same way as t is used to calculate T in CHL.

The wallet seed s in CHL is given by

s=s′+r′,

where Alice 602 randomly chooses s′, and the bank contributes r′. s′ is derived from another random variable in the following way

s′:=hash(g^{s″}),

where s″ is this new random variable and is interpreted as Alice's contribution to the wallet seed. Therefore, the wallet seed s is now defined to be

s=hash(g^{s″})+r′,

where Alice randomly chooses s″ and the bank 601 randomly chooses r′. The purpose of redefining the seed s in this way it is immediately derivable from a new double-spend equation

Z=g^{s″}g^{R/(z}^{₁}^{+J+1)},

which provides the same features as T in the original implementation (see below for a description of the CHL protocol), with the result that if Alice 602 double-spends, her seed will now be derivable by the bank 601. This is done in the following way. If Alice 602 double-spends, the bank 601 will know two different values of Z and R, labelled by Z₁, R₁, Z₂, R₂. Then they calculate

$${( \frac{{Z}_{2}^{{R}_{1}}}{{Z}_{1}^{{R}_{2}}} )}^{{( {R}_{1} - {R}_{2} )}^{- 1}} = {g}^{{s}^{″}} ,$$

and can calculate the full seed

s=hash(g^{s″})+r′,

where r′ is the bank's own contribution, which they have stored with Alice's information at withdrawal. Then, the remaining serial numbers can be calculated using the equation for the coin serial numbers

S=F_{g,s}^{DY}(J),

for all remaining J<2^{l}^{_{J}}. The bank 601 can then blacklist all these unspent coins in her wallet by publishing the unspent serial numbers. This process can be repeated for any number of additional secrets, provided the secrets are of the form g^{▪}. This double-spending value Z now is included in the exchange of the coin. At this point, the bank 601 has issued a wallet to Alice 602 with the form

W=(u,s,t,z₁,σ_{B}(u,s,t,z₁),J)

and so the bank 601 broadcasts a transaction as given in FIG. 7a.

The first output contains a 1-of-2 multisig which can be unlocked by Alice P_{A} or the bank P_{B}, and the hash of the serial number of the first coin. All later coin outputs also have this format. This means that in order to unlock any of these outputs, one needs to know the serial number of the coin, which at this point only Alice 602 knows. The bank 601 will only be able to calculate the serial numbers of the coins before they appear on chain in the case of Alice 602 double-spending. Then they can spend any coin outputs of this form, resulting in a blacklisting of the coins. This extra requirement in the locking script means that the bank 601 cannot maliciously blacklist coins. Note that since the serial numbers are on chain, it is more secure for Alice 602 to spend the serial numbers in a random order. One way to do this, without needing to store all the spend serial numbers, is to pick a∈J at random, and b∈[1, 2^{l}^{_{J}}) such that the greatest common divisor gcd(b, 2^{l}^{_{J}})=1. Then choose Jᵢ=a+i·b mod 2ⁱ^{_{J}} to spend the i^{th} coin. With this process, she does not need to keep track of the serial numbers of the coins she has already spent, only the total number spent and the initial values a and b, as the counter will not be repeated until all coins are spent. The second output in the transaction is simply change back to the bank 601.

Finally, the data given in the OP_RETURN output is given in FIG. 7b, where the first field specifies which fiat currency the coin represents, the coin protocol flag specifies which digital cash protocol the coin was issued using, the coin action flag specifies which action this transaction corresponds to, which in this case is withdrawal, and the value of the coin is the number of coins that have been withdrawn. In this example, 64 coins are issued. After this, there is the option to add any additional information if required.

Multiple coins can be issued at once. As one option, the balance of the wallet can be given in the OP_RETURN data. Then anyone accepting a coin from Alice 602 can check that balance and the value of previous spends coincide. This also provides assurance that the counter is in the correct range. In this case, it is easy to spend multiple coins at once, as they can be easily listed in OP_RETURN. As another option, there can be multiple P2PKH outputs in the withdrawal transaction. Then every output represents a single coin, and one output is spent each time one coin is spent. The balance of the wallet is easily calculable by the number of unspent outputs of the transaction, and blacklisting coins is easy in this protocol as spending their corresponding unspent transaction output (UTXO) will result in blacklisting. The drawback with this case is that if the number of coins issued is large, then the number of UTXOs will be large, which places strain on miners to keep this data stored.

There are benefits and drawbacks to each case; the preferred case will depend on the situation. The first option is used in this example traceable protocol.

In this example protocol, in order to spend a coin, Alice 602 provides the merchant 603 with:
the serial number of the coin,
the double-spending equations, which are calculated using R, which Alice obtains from the merchant,
a zero-knowledge proof that all these equations are formed correctly, a zero-knowledge proof of knowledge of a signature σ_{B} is a signature by the bank on the values (u, s, t, z₁),
a proof that the counter J is in the correct range, and the withdrawal transaction, and any further spending transactions.

Assume Alice 602 withdraws X coins. The serial number of these coins all have the same seed ‘s’, and so to create different serial numbers, there may also be a counter in the coins that goes from 1 to X, and including this counter in the serial number essentially means that each coin has a different serial number. Alice 602 may be required to prove that a given serial number was derived from the seed and the counter. The range can be arbitrary, e.g. from 1, . . . , X. However there is nothing stopping her from creating a coin serial number derived from X+1, X+2, . . . , and saying that this is a coin withdrawn from the bank 602, and here is the proof of the seed being signed. So to prevent this, Alice includes a proof that the counter value is between 1, . . . , X.

In more detail, in order to spend a coin, Alice 602 and the merchant 603 carry out the following steps. Alice 602 computes R=H(pk_{M} ∥ info) where info is some variable chosen by the merchant 603, and H is some collision-resistant hash function. The info needs to be something that will change with each transaction to ensure that the corresponding double-spending equations will be different, such as the time and date of the spend, invoice of the spend, or a transaction counter. Alice 602 calculates the coin serial number and double-spending equation

S=F_{g,s}^{DY}(J),

T=pkᵤF_{g,t}^{DY}(J)^{R},

Z=g^{s″}F_{g,t}^{DY}(J)^{R}

where

F_{g,r}^{DY}(x)=g^{1/r+x+1},

is the DY pseudorandom function given in the preliminary section. Since the double-spending value depends on the merchant ID, and their input info, these cannot be calculated prior to this.

Alice 602 sends a zero-knowledge proof of knowledge of (u, s, t, z₁, σ_{B},J), which is turned into a single signature Φ on a message in the following way. The signature proves that J is in the correct range, S, T and Z are formed correctly, and the signature σ_{B} is formed correctly. This is done in the following way. Let A=PedCom(J). Prove A is a commitment to an integer in the range [0, 2^{l}^{_{J}}). Let B=PedCom(u), C=PedCom(s), D=PedCom(t), E=PedCom(z₁) prove knowledge of a CL signature on u, s, t and z₁ without revealing them. Prove that the serial number S and double-spending equation T are formed correctly. Then the signature is on the message (S, T, A, B, C, D, E, [symbol] , [symbol] , n, g, pk_{M}, R, info).

Finally, the coin that Alice 602 is spending has the form

(S,R,T,Z,Φ).

If the signature Φ verifies, then the merchant accepts the coin (S, R, T, Z, Φ). Note that Φ acts as proof to the bank that the merchant 603 acted correctly. Finally, Alice 602 updates her counter J=J+1. When J>2^{l}^{_{J}}−1, the wallet is empty.

If the merchant 603 is provided with the withdrawal transaction and the chain of all coin spends leading from this transaction, then this proves to the merchant 603 that the coins were issued by the bank 601. Alice 602 then needs to prove that the serial number and double-spending equations are calculated correctly from the seeds s, t, z₁, and counter J, that the bank 601 has signed the value (u, s, t, z₁), and that the counter is in the correct range. This is summarised with a zero-knowledge proof of knowledge signature Φ on the message,

(S,T,A,B,C,D,E, [symbol] , [symbol] ,n,g,pk_{M},R,info).

With this information, the merchant 603 must first check that the coin has not already been spent or blacklisted. The merchant 603 does this by checking that the coin has not already appeared in an OP_RETURN data field in a transaction. If they find it has already appeared, they reject the coin. Otherwise they check the zero-knowledge proof of the serial number and double-spending equations being correctly formed, and that J is in the correct range. Additionally, the merchant 603 can check that the number of spent coins and the balance of the wallet coincide. If the coin passes these checks then the merchant 603 accepts the coin. Once the merchant 603 accepts a coin, Alice 602 and the merchant 603 create the spend transaction given in FIG. 8a.

Alice 602 creates the transaction by signing the output of the withdrawal transaction as her input. She then creates 3 outputs. The first output corresponds to the next coin that Alice 602 wishes to spend, such that this spend protocol can be repeated. The second output will be used for the deposit of the coin with the bank 601. The third output contains the data of the coin being spent. Since she needs to sign 3 outputs, she uses the flag SIGHASH_ALL|SIGHASH_ANYONECANPAY. Because Alice 602 uses this particular flag, the merchant 603 can only add their input but no outputs after Alice 602 has signed it. The input from the merchant 603 is required such that there is a record that they have accepted the coin as payment from Alice 602. Alternatively, asking the merchant 603 to sign the transaction first will also require exchange of some transaction data, and so it is more beneficial to have Alice 602 sign the transaction first and send it along with the zero-knowledge proofs of knowledge. The merchant 603 then signs the transaction with their input and broadcasts it to the blockchain network.

Note that to unlock the second output, it must have two of three signatures. If a deposit is accepted, this will be the merchant 603 and the bank 601. The other combinations of signers are simply for security if one of the parties acts maliciously. Note that in this protocol, the bank 601 will only accept digital coins if the deposit transaction below contains this output, signed with their own public key P_{B}, and the merchants public key P_{M}. The final output contains data in the form of FIG. 8b. This transaction is confirmation that a merchant 603 has received a coin. Since R is dependent on the merchant ID, no one aside from the merchant 603 can deposit the coin. The coin serial number is now on chain so no other merchant should accept a coin with the same serial number. If Alice 602 presents a merchant 603 with a serial number that is already on chain, then this merchant can still publish the coin information S, R, T, Z even if they do not accept it. This means that the bank 601 is able to calculate any remaining unspent coins in her wallet and blacklist them. There is the option to have a reward for merchants who hand in double-spenders.

In this protocol, the merchant 603 can wait to contact the bank 601 to deposit the coin, as the serial number is on chain, and if double-spending does occur, it can be identified already at this point. During deposit, the bank 601 must make the same checks as the merchant 603, and additionally check that the preimage of R is indeed the ID of the merchant (and some other information info). The bank 601 also checks that all previous transactions have the correct form and refuses a deposit that does not—this ensures that all users will stick to the protocol. Once a serial number is presented and is found to not be a double-spend, the merchant 603 and bank 601 will sign the deposit transaction, shown in FIG. 9a, which acts as confirmation that the coin has been deposited. The merchant 603 creates a transaction template, signing the input, and then can send this at the same time as the other information about the coin. The bank 601 then adds their signature to the input and broadcasts the transaction to the blockchain. This transaction signifies that the bank 601 has accepted a deposited coin from a merchant 603. The data has the form of FIG. 9b.

To deposit a coin, the merchant 603 gives the coin (S, R, T, Z, Φ) to the bank 601. If Φ verifies and R has not been deposited previously (i.e. (S,R) is not already in the list of spend coins), then the bank adds (S, R, T, Z, Φ) to the list and credits the merchants account. If the bank 601 finds that the coin serial number S is already in the database, they check if R is also the same. There are then two possible situations.

If R is the same, the bank 601 assumes that the merchant 603 has already deposited the coin and they are culpable. In this case, it could be either only the merchant 603 that is culpable, or both Alice 602 and the merchant 603. It is safe for the bank 601 to assume this as the merchant 603 has no reason to collude with Alice 602. In this situation, Alice 602 cannot be identified and punished, so it will only be the merchant 603 that loses out. This case is resolved using the blockchain, by utilising the binary nature of transaction outputs being only unspent or spent. Therefore either case of double-spending is simply not possible when using the blockchain.

If R is different, then it must be at least Alice 602 that acted dishonestly (and possibly the merchant 603 as well), and the bank 601 can calculate both their identities. To calculate Alice's identity, the following calculation is done. Denote the previous database entry as R₁, T₁ and the current values as R₂, T₂. Then the bank 601 can calculate Alice's public key using

$${( \frac{{T}_{2}^{{R}_{1}}}{{T}_{1}^{{R}_{2}}} )}^{{( {R}_{1} - {R}_{2} )}^{- 1}} = {g}^{u} .$$

There is an equivalent calculation corresponding to Z₁ and Z₂ resulting in g^{s″} which can be used to derive all coin serial numbers, and therefore blacklist unspent ones.

Finally, in the case of the merchant 603 being culpable as well, info would be different and pk_{M} would be equivalent in both versions of the double-spent coin. Since both info and pk_{M} is stored with each deposit, the bank 601 can immediately detect this, and they are able to punish both Alice 602 and the merchant 603. Therefore, there is no motivation for either parties to collude.

If it is the case that the coin is double-spent, where a coin serial number occurs on the blockchain twice, then the bank 601 will only accept the coin that appeared first. The bank 601 then uses equations from both occurrences to calculate the identity of the double-spender using the double-spend values T₁, T₂ and the merchant IDs R₁, R₂. Additionally, the seed can be calculated from Z₁, Z₂ and R₁, R₂, in a similar way. These calculations are shown above. The bank 601 can then calculate Alice's identity g^{u} and coin seed s. Then the bank 601 can derive the serial numbers corresponding to Alice 602, and publish these on chain, blacklisting the coins. This protocol naturally allows for the option to reward a merchant 603 for handing Alice 602 in to the bank 601, by the bank including a payment to the merchant 603 in the transaction above.

Recall, that if it is the case that a double spent coin has the same serial number and merchant ID, the bank 601 knows that the merchant 603 must be culpable. If a deposit follows exactly all the transactions described above, then it will never be possible for a merchant 603 to deposit a coin twice in this protocol, since the first deposit will spend the UTXO required for the second deposit.

Untraceable Digital Coins (CHL)

This example protocol removes the traceability of the coins, resulting in an increase of the load on the merchant 603 and bank 601 to verify that the coins were correctly issued. This load will include the same checks carried out in the traceable protocol described above, with the additional feature that double-spending is not possible—any attempt at double-spending can be detected immediately.

Similar to the traceable protocol, Alice 602 wants to withdraw some digital coins from the bank 601, spend them with a merchant 603, and then the merchant 603 deposits them with the bank 601. The setup is the same as the previous setup. The bank 601 has a public/private key pair (pk_{B}, sk_{B}). The bank's public key is then (n, a₁, . . . , a₄, b, c) and the private key is p₁ such that n=p₁p₂ is a special RSA modulus. Additionally, Alice 602 and the merchant 603 each have their own unique key pair such that (pkᵤ, skᵤ)=(g^{u}, u) for some u∈ [symbol] ₘ, where m is prime, and g∈G as before. All users also have their own EC public/private key pair of the form (pk=sk·G, sk), such that they can receive and spend bitcoin. Alice's key pair is denoted (P_{A}, sk_{A}), the bank's key pair is given by (P_{B}, sk_{B}), and finally, the merchant's key pair is (P_{M}, sk_{M}).

In this protocol, Alice 602 withdraws a wallet with the form

W=(u,s,t,z₁,σ_{B}(u,s,t,z₁),J),

where u is Alice's private key, s is the seed of the coin serial numbers, t, z₁ are seeds of the double-spending equations, σ_{B} is the signature by the bank 601 on the secrets, and J is the counter of the wallet. Alice 602 broadcasts a transaction to acknowledge the withdrawal. For an untraceable protocol, there should be a withdrawal transaction corresponding to each coin in her wallet, and these then will not be linked. Alice 602 creates the withdrawal transaction at a later time to the wallet withdrawal from the bank 601. If she does it at the same time, it is likely that the bank 601 will be able to know which withdrawal the transaction corresponds to. In practice the ease of identifying Alice 602 will depend on the number of users of the ecash system. If there is just one (or a few) user, the user(s) will be easily identifiable by the bank 601 no matter when they put the withdrawal transaction on chain.

Alice 602 creates her own withdrawal transaction representing each coin. Note that the fact that Alice 602, rather than the bank 601, creates the withdrawal transaction is the key difference between the traceable and untraceable protocol. This transaction has the form given in FIG. 10a. This transaction represents a single coin. As before, the locking script contains the hash of the coin so that the bank 601 can only spend the output if they know the serial number of the coin, which will happen only when Alice 602 double-spends.

The OP_RETURN data is shown in FIG. 10b. In this protocol, coins have a set value and so the balance is not required, as each UTXO represents 1 unit of value. Alice 602 can create this transaction whenever she wants, provided it is created before the spend protocol is initiated. As mentioned, it is more secure for Alice 602 to create this transaction at a random time after the withdrawal, and at different times than transactions corresponding to the other coins in the wallet, as this will compromise on privacy. A bank 601 will not accept a deposited coin unless the corresponding withdrawal transaction has this format. This prevents Alice 602 from acting maliciously, such as creating an output which cannot be spent by the bank 601.

In order to spend a coin, Alice 602 provides the merchant with the serial number of the coin, the double-spending equations, the zero-knowledge proof that these are formed correctly with the wallet secrets, the zero-knowledge proof of knowledge of a signature by the bank 601 on the wallet secrets, the zero-knowledge proof that the counter is within the correct range, and the withdrawal transaction.

The proofs are all sent as one signature of knowledge Φ on the message

(S,T,A,B,C,D,E, [symbol] , [symbol] ,n,g,pk_{M},R,info),

where there is an additional commitment E corresponding to the additional secret z₁, defined as

E=PedCom(z₁).

First, the merchant 603 must check that the serial number has not already appeared on the blockchain. This check is utilising the immutable history of the blockchain. If the coin serial number is not found in this search, it is impossible for it to have ever appeared on the blockchain, and the merchant 603 can be sure that it has therefore never been spent. If the blockchain search is found to be clear, Alice 602 must next prove to the merchant 603 that the serial number and double-spending equations are all formed correctly. Finally, Alice 602 must prove that the counter is within the correct range.

Once the merchant 603 accepts a coin, they make a spend transaction as shown in FIG. 11a. In this transaction, Alice 602 adds her input and signs only the first output using SIGHASH_SINGLE|SIGHASH_ANYONECANPAY. The hash of the OP_RETURN data<h₂=SHA-256(data₂)> is included in the output so that Alice 602 indirectly signs it and it cannot be changed. She then sends this to the merchant 603 who will add their input and change back to themselves and sign the whole transaction. Their input is included to represent a signature from them on accepting the coin.

The first output is the output that will be used in the deposit transaction, signed by the merchant 603 and the bank 601. The other combinations of signing are included in case one party acts maliciously. This first output is equivalent to the second output in the traceable spend transaction. The second output in this case is simply change back to the merchant 603 and the final output is data which is shown in FIG. 11b.

This transaction is a record by the merchant 603 that they have received a coin without sharing all the information needed to deposit it, since no one except themselves know the preimage of R as before. Additionally, the signature on the proofs of knowledge is kept secret. The only information that is shared here is that which is needed to identify double-spenders, and the remaining knowledge is hidden until the coin is deposited. Note that if the merchant 603 finds that Alice 602 is attempting a double-spend, the bank 601 can incentivise them to pass on the details of the coin so that Alice 602 can be identified.

The merchant 603 now contacts the bank 601 to deposit the coin whenever is convenient for them. The bank 601 will only accept the coin that appeared in a spend transaction first, and where all previous transactions have the correct format. The merchant 603 gives the bank 601 the transaction, preimage of R, and the signature (D. The bank 601 then confirms that this is the first time that the serial number S and R has been presented to them and that the serial number is not blacklisted, by searching the blockchain for the data. They should only appear once and within the transaction that they have been presented with. If this holds true, the bank 601 verifies the same proofs as the merchant 603, and additionally the withdrawal and spend transactions are correctly formed. If all these checks are passed, the deposit transaction of FIG. 12a will be published to the blockchain.

This transaction signifies that the merchant 603 has deposited coins and that the bank 601 has accepted it. The input is from the spending transaction and is signed by both the merchant 603 and the bank 601, signifying they both have taken part in this interaction. The first output is simply change back to the bank (if there is any), and the second output contains the data shown in FIG. 12b. There is a space for publishing double-spent serial numbers. If a deposit is found to be of a double-spent coin, then the bank 601 can check if Alice 602 or the merchant 603 is culpable. If it is a coin with the same serial number and merchant ID R, then the merchant 603 is assumed to be culpable and the bank 601 rejects the coin. If the merchant ID is different, then it is Alice 602 who is culpable. The bank 601 can then calculate Alice's key g^{u} and her seed s′ using the double-spending equations and from this calculate all the serial numbers, spend all the UTXOs that Alice 602 created, and additionally publish the serial numbers on chain.

The biggest benefit of this system over the first is that coins are fully untraceable. The bank 601 can know they have issued coins to Alice 602, and they can know that a merchant 603 has deposited coins, but they do not know which route the coins take from withdrawal to spending, unless they are the result of a double-spend.

Both the traceable and untraceable protocols prevent anyone double-spending at the point of sale as the merchants check for previously spent coins at this point, instead of checking at deposit time. This will be true for any digital coin system that is implemented in this way. Additionally, the digital coins are now easily auditable as all transaction data is published on the blockchain. Anyone involved in the protocol can prove their involvement to an auditor.

These protocols improve on previous ecash systems using two properties of the blockchain. The first property that is used is the fact that the blockchain is a distributed, immutable database such that the list of spent coins is publicly available to anyone. This makes it easier for anyone accepting coins to check if they are already spent. Additionally, these protocols utilise the binary status of transactions of outputs either being spent or unspent. Once the status of an output changes from unspent to spent, it cannot be spent again, and so double-spending is simply not possible.

Each stage of withdrawal, spend, and deposit of a coin may be connected, and therefore ‘traceable’ in some sense. Anyone can see that a digital coin has been withdrawn, spent, and deposited, but the identity of users will be hidden to everyone except those with knowledge of the identities corresponding to the public keys used in each transaction (which is feature of the blockchain in general). The key difference is that in the traceable protocol, the bank 601 will know exactly who withdrew the coin(s), but in the untraceable protocol, the bank 601 will not know the identity of the withdrawer at the time of deposit.

The following describes several example ecash protocols which can be implemented using the generic transaction of FIGS. 13a to 13c by specifying the contents of the OP_RETURN data.

Chaum Ecash Protocol

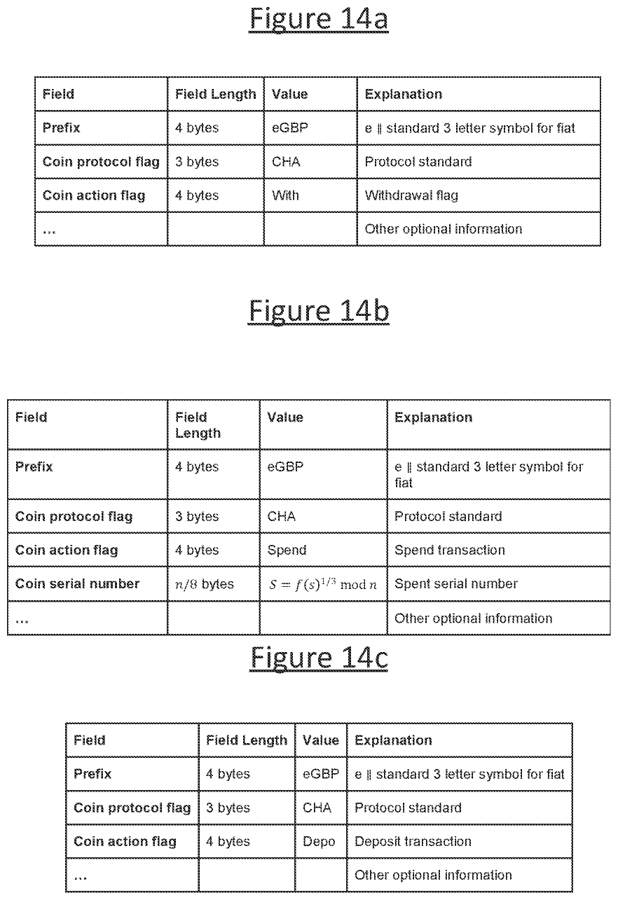

FIGS. 14a to 14c respectively illustrate example OP_RETURN data for withdrawal, spending and deposit transactions according to this protocol. Chaum's is an online ecash system, meaning that the bank must be online to accept any coins at the time they are spent. Moving this protocol on chain makes the ecash protocol offline.

Alice wants to obtain a coin from the bank, and she will spend it with a merchant. The bank chooses two RSA primes, p, q, and computes n=p·q, and keeps the factorization secret. Then the m^{th} root of an integer mod n is computationally infeasible to calculate without knowledge of the prime factorisation. This concept takes the role of the banks signature on the coin. The coin has the form

(s,ƒ(s)^{1/3} mod n),

where ƒ is some one-way function, such as a hash function, and is publicly known, and s is a random seed of the coin. Then ƒ(s)^{1/3} mod n is the coin serial number. The calculation of the third root by the bank is a signature by the bank on the coin. The third root is an arbitrary choice, and it could be a calculation of the m^{th} root of ƒ(s) mod n for any m≥2, as long as the choice of m is constant for all withdrawn ecash. In order to issue the coin, the following steps are taken.

Alice chooses a random coin seed s and blinding value r and sends the bank the ‘blinded’ coin serial number B=r³·ƒ(s) mod n. The bank returns the cube root of B, which only they can calculate B^{1/3}=r·ƒ(s)^{1/3} mod n, and deducts £1 from Alice's account. This calculation of the cube root represents a signature on the bank. This is because only the bank knows the factorisation of n and therefore only they can calculate cube roots modulo n. Note there is always exactly one cube root modulo n=pq. On the other hand, since the bank doesn't know the value of r, they are not able to determine the coin serial number ƒ(s)^{1/3} mod n. However, they will know they have computed this value, as no one else is able to. Alice unblinds the coin serial number by multiplying this result by the inverse of her blinding value r⁻¹

C=r⁻¹·B^{1/3}=ƒ(s)^{1/3} mod n,

such that she now has the coin which is made up of the seed and the coin serial number (s, ƒ(s)^{1/3} mod n). Alice then stores this, ready to spend when she requires.

It is important to note that the bank does not know the explicit value of ƒ(s)^{1/3} mod n at this point, and so when it is deposited in the future, they cannot link it to this interaction. However, they will know that they ‘signed’ it, as they can check that it is a cube root modulo n, and only they have the capability to calculate this. In this example, it is only possible to withdraw a single coin. To withdraw more than one coin, this protocol is to be repeated for different s and r.

To pay a merchant £1, Alice gives them exactly this coin. The merchant checks that the coin is the correct form by calculating the cube of the coin serial number, and additionally calculating the value of the public function ƒ from the given s value

C³=ƒ(s)^{1/3})³ mod n,

C′=ƒ(s)mod n,

and compare the two values. If they are the same, then the coin is formed correctly.

Before utilizing the blockchain, the merchant would call the bank and verify that the coin has not already been spent, before accepting the coin. The bank could then additionally check that this coin has the correct form by calculating the same result as the merchant. Once the coin is verified, the bank would add this coin serial number to their database.

The major benefit of using the blockchain to record Chaumian ecash is that it takes the protocol offline. A merchant, rather than contacting the bank to check the database immediately, can check this distributed database themselves, and reject coins that are already spent. This is true for any online protocol: they can be moved offline with the blockchain.

Additionally, the binary nature of UTXOs means that double-spends or attempts to deposit a coin twice simply cannot occur in the traceable protocol. This is because the bank will not sign the same coin more than once, and there is single spendable UTXO of the withdrawal transaction representing the coin. Then, similarly, the deposit can only occur once, as the UTXO of the corresponding withdrawal transaction can only be spent once. In the untraceable protocol, this relies on both this UTXO property, and the distributed database property. The merchant and bank must now ensure that no other withdrawal transactions have been created that correspond to the same coin. This is sufficient to improve on the Chaumian ecash.

Untraceable Ecash

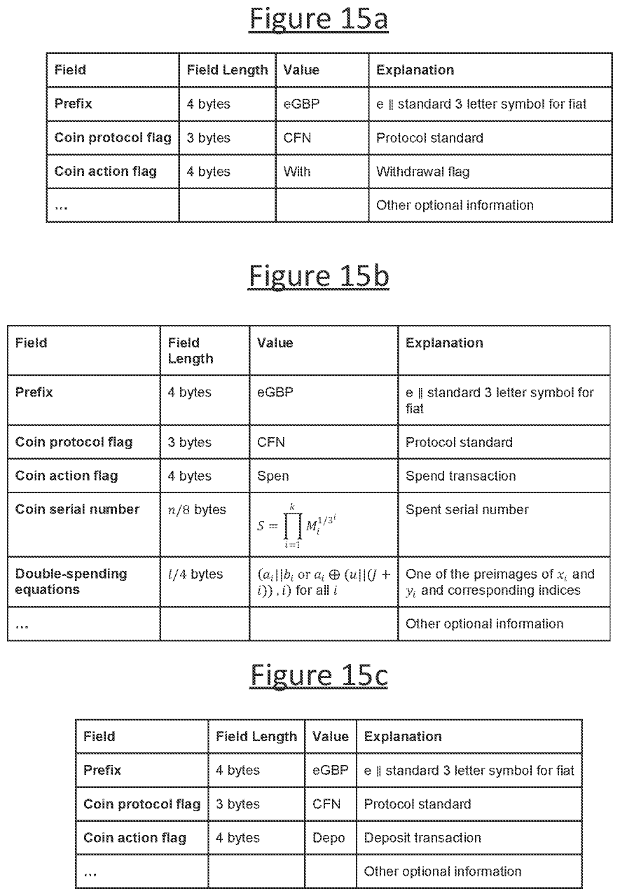

FIGS. 15a to 15c respectively illustrate example OP_RETURN data for withdrawal, spending and deposit transactions according to this protocol.

The Chaum ecash system above can be extended such that the cash can be spent offline without using the blockchain. This is done by incorporating the identity of the withdrawer in the coin, and then if they double-spend their identity can be calculated. It is also possible to withdraw more value at one time (and another value at a different time). This means that a merchant can wait to deposit the coin, and if it is a double-spend, it is possible to calculate the double-spender's identity. Additionally, in this protocol, Alice can spend coins up to the withdrawn value of 2^{j}−1 and then obtain the change from any unspent value. However, she cannot spend the change at another merchant.

In this system, the bank publishes two RSA integers n, n′ such that n=p·q and n′=p′. q′, where p, q, p′, q′ are primes, and the factorizations remain secret. In this implementation, Alice's bank account number is denoted by u, and her coin counter by j. If she double-spends, her bank account number will be derivable, as we shall see. Two-argument collision-free functions ƒ, g are publicly known. That is, there are two functions which have two-arguments.

If Alice wishes to withdraw a coin of value 2^{j}−1, she sends the bank t pairs of equations, which we call ‘major’ and ‘minor’ candidates. The major candidates will contribute to the serial number of the coin, and double-spending prevention. Then the minor candidates are used to obtain change from the transaction. Additionally, we shall see the relation between the number of pairs t and how many coins Alice would like to withdraw. For each major candidate, Alice chooses aᵢ, bᵢ, cᵢ, dᵢ, eᵢ, rᵢ at random which have a bit length of l, for i=1, . . . t. A major candidate Mᵢ is of the form

Mᵢ=ƒ(xᵢ,yᵢ),

where

xᵢ=g(aᵢ∥bᵢ,cᵢ),

and

yᵢ=g(aᵢ⊕(u∥(J+i),dⁱ)

where ⊕ is the xor symbol and ∥ means concatenation. Each minor candidate mᵢ is given by mᵢ=g(bᵢ, eᵢ).

Alice blinds the candidates with the random values rᵢ

B(Mᵢ)=r₁³^{^{k}}·Mᵢ mod n,

where k is the number of major candidates in the coin. Note that the first j candidates will represent the binary digits up to 2^{j}−1, and then the remaining k−j major candidates in a coin will prevent double-spending. This means that the larger k−j is, the higher chance of catching double-spenders. The blinded minor candidates are

B(mᵢ)=r³^{^{k}}·mᵢ mod n′.

Alice sends the blinded candidates to the bank. The bank randomly selects half the pairs and verifies explicitly that they have the proper form. There are then t/2 pairs remaining that the bank doesn't know the value of. They can be assumed to be correct as the bank randomly verifies half of the t pairs that they are presented with. In this example, Alice is withdrawing one coin of value 2^{j}−1, but it may be that she has sent more candidates which can be split into multiple coins at this point. This is done by the bank who simply splits the remaining major candidates into sets of size k. In this way, the size of t is dependent on the number of coins Alice wishes to withdraw. The bank chooses the order of the remaining candidates then extracts the following roots

| | |
|---|---|
| Fᵢ = B(Mᵢ)^{1/3}^{ⁱ} mod n | for 1 ≤ i ≤ k, |
| Dᵢ = B(mᵢ)^{1/3}^{ⁱ} mod n′ | for 1 ≤ i ≤ j. |

The bank returns the product of the blinded major candidates

$${\prod }_{i = 1}^{k} {F}_{i}$$

and returns the minor candidates individually. The bank then records that a coin with total value 2^{j}−1 have been issued. Alice then extracts the major candidates:

$$S = {\prod }_{i = 1}^{k} {M}_{i}^{1 / {3}^{i}}$$

and Eᵢ=mᵢ^{1/3}^{ⁱ} for the minor candidates. Alice now has a coin that she can spend up to its value of 2^{j}−1, and obtain any change on the unspent value.

In order to make a purchase, Alice first labels the first j of the M_{i.} as denominations 1, 2, . . . , 2^{j-1}. Then Alice reveals one of two things to the merchant for each 0<i≤j. If the ith denomination is a term in the purchase sum, then Alice reveals yᵢ and preimage of xᵢ to the merchant. If the ith denomination is not in the purchase sum, then Alice reveals just xᵢ and yᵢ. The final k−j terms are used to prevent double-spends in the following way. The merchant chooses a random binary string zⱼ₊₁, . . . , zₖ. If zₗ=1 with j<l≤k, Alice reveals yᵢ and the preimages of xᵢ to the merchant. If zₗ=0 with j<l≤k, Alice reveals xᵢ and the preimages of yᵢ to the merchant. Then if Alice double-spends, there is a high likelihood of the merchants choosing different strings, and it would be possible to calculate Alice's account number from any of the colliding bits zₗ, and it is for this reason that double-spending prevention is more secure the larger k−j is. Alice gives all the relevant preimages of the coin to the merchant.

The bank verifies that the coin has not been spent before by checking the blockchain and/or their off-chain database of spent coins (the database may be stored on chain). If not, the bank then adds S and the preimages given to the merchant to the database. For Alice to obtain change, she takes the Eᵢ and pre-images bᵢ and eᵢ to the bank for a refund. The bank will compare i and bᵢ to previously spent coins and identify Alice as a double-spender if they have been presented before.

There is potential for Alice to spend a coin with a merchant and then obtain a refund before a merchant contacts the bank. If a bank stores her identity with the change transaction, then they can identify her and charge her account. However, if she has taken the value out as cash again, there is no way to prevent this being spent provided she acts honestly. This attack can be prevented by using the blockchain as we shall explain below.

It is possible to modify this scheme so that all coins withdrawn by Alice are invalidated once a double-spend has been detected. This is done by linking the initial candidates within a matrix, where they each have indices corresponding to their location in the matrix. Then coins can be blacklisted by the bank by publishing the blacklist on chain, and merchants can check any presented coins against this blacklist.

Moving this ecash system on chain prevents double-spending at the point of spend, rather than the point of deposit. They can also report this attempt at double-spending to the bank who will be able to trace Alice by her signature on the change transaction in the case of the traceable protocol. Finally, any double-spenders will have their identity derivable from the information that is presented on chain. This gives another deterrent for users to attempt double-spending.

Endorsed Ecash

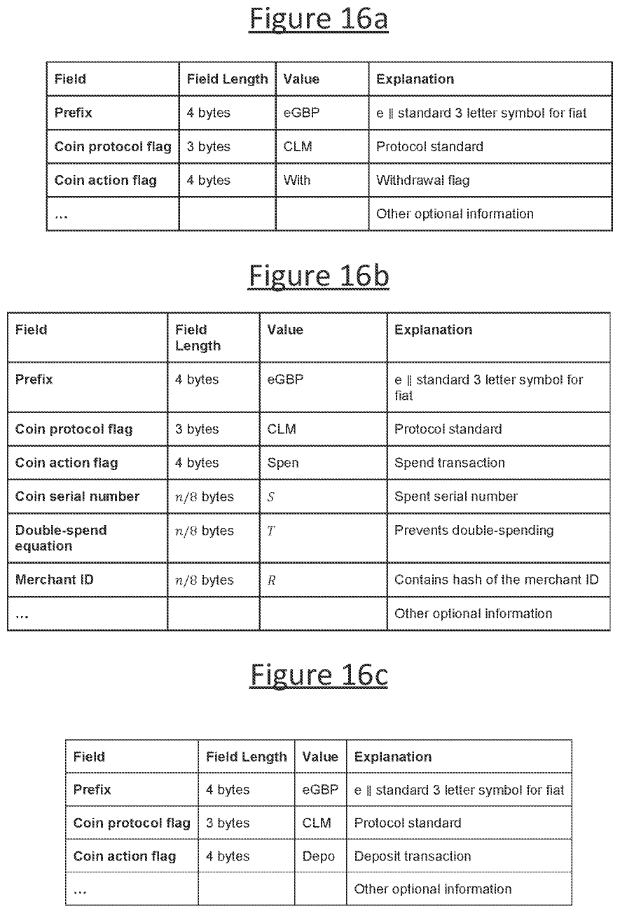

FIGS. 16a to 16c respectively illustrate example OP_RETURN data for withdrawal, spending and deposit transactions according to this protocol.

This ecash can be exchanged as unendorsed ecash, such that Alice can prove she owns a coin before revealing the full coin.

This protocol has the same set up and withdrawal as the CHL protocol. For Alice to spend ecash with a merchant, they execute the following steps. Before giving the merchant the coin serial number S and double-spending equation T, Alice first chooses a random endorsement (x₁, x₂, x₃). She calculates the unendorsed coin (S′, T′, Φ′, R, y) where S′=Sg^{x}^{₁}, T′=Tg^{x}^{₂} and y=PedCom(x₁, x₂, x₃). Φ′ is the zero-knowledge proof that the unendorsed coin (J, u, s, t, σ_{B}, x₁, x₂, x₃) is valid. Note that S′, T′ are simply intermediary values, that she will endorse, such that the actual coin represented by S, T will be the values that are eventually given to the bank. These values S, T have been described above. The unendorsed coin is a blinded coin that can then be given to the merchant. They can verify Φ and check that the unendorsed coin is valid, similar to CHL. When Alice and the merchant are happy to continue with the exchange, the merchant is given the endorsement (x₁, x₂, x₃). Using this, they can easily calculate the endorsed coin

(S,T,Φ′,R,(x₁,x₂,x₃),y)

using the following equations

S=S′/g^{x}^{₁},

T=T′/g^{x}^{₂},

which then results in the same equations as previously described. The difference between this endorsed ecash and the CHL protocol is only the signatures Φ≠Φ′, but Φ′ is still sufficient proof that the coin was correctly issued by the bank.

Alice can create as many unendorsed coins as she wishes, yet still be identified if and only if she double-spends. This process allows Alice to show that she has a coin without sharing the coin, meaning that she can prove to a merchant that she does indeed own a coin.

Additionally, if a sale does not go through, Alice can still use her unendorsed coin elsewhere without being identified. In CHL, if Alice gives a coin to a merchant and the exchange does not go through for any reason, she cannot use her coin elsewhere without the possibility of being identified. Two different merchants would have the same serial number with different double-spending equations, and then the double-spending equations can be used to calculate her identity.

In this protocol, the merchant deposits the coin (S, T, Φ′, R, (x₁, x₂, x₃), y) and the bank can verify the same conditions as the CHL coin, plus the new signature Φ′ being on (u, s, t, σ_{B}, J, x₁, x₂, x₃). The bank can identify double-spenders in the same way as before by storing (S, T, R) for any presented coin on the blockchain.

As with the other ecash protocols, double-spending is now prevented at the point of spend, rather than deposit. This is because the merchant can check this distributed database for previously spent coins. Additionally, the traceable ecash prevents double-spending by the impossibility of double-spending UTXOs. The untraceable ecash relies on this and the fact that anyone can check for previously spent coins. In this protocol, as with others, it will also be possible for anyone to calculate the identity of double-spenders, and so this acts as another deterrent at attempts of double-spending.

Practical Compact Ecash

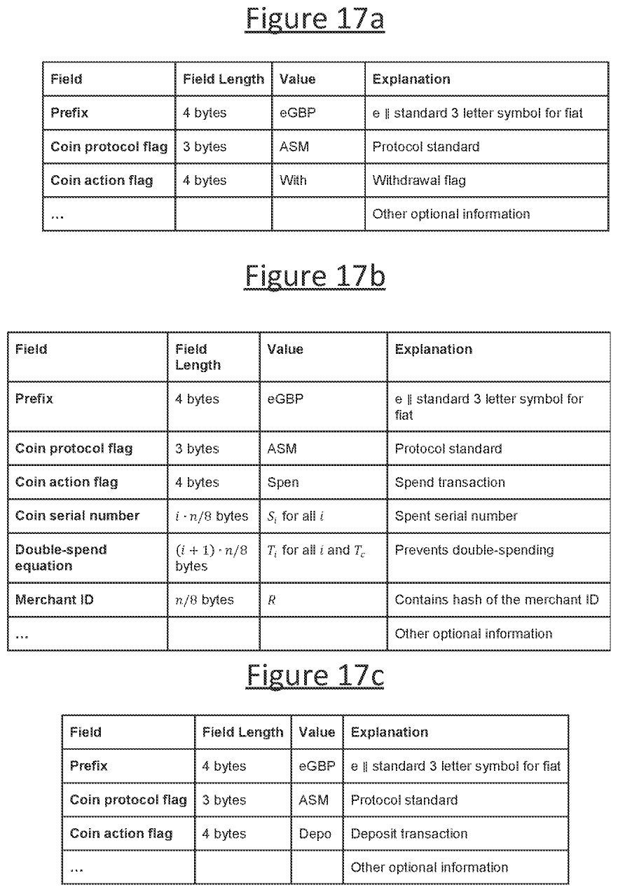

FIGS. 17a to 17c respectively illustrate example OP_RETURN data for withdrawal, spending and deposit transactions according to this protocol.

This protocol allows for spending multiple coins at a time: either the full wallet at once, which is referred to as ‘compact’ spending, or multiple coins at once which is referred to as ‘batch’ spending.

This is similar to the original CHL protocol, but the bank needs to sign four messages (instead of three) with the signature, and they additionally sign integers that represent signatures on a counter. Assume that the bank has a public/private key pair (pk_{B},sk_{B}) such that they can sign four messages with one signature, using the CL signature scheme. That means is the public key has the form (n, a₁, . . . , a₄, b, c) and the private key is Pₜ such that n=p₁p₂ is a special RSA modulus. Additionally, Alice and the merchant each generate a unique key pair such that (pkᵤ, skᵤ)=(g^{u}, u) for some u∈ [symbol] ₘ, where m is prime, and g∈G. Finally, the integers that the bank signs are published, σ_{B}(1), σ_{B}(2), . . . , σ_{B} (k), where k=2^{l}, the number of coins being withdrawn. We call these σr₁:=σ_{B}(1), σ₂:=σ_{B}(2), . . . , σₖ:=σ_{B}(k=2^{l}).

The withdrawal is very similar to a CHL withdrawal. The only difference is that the bank signs an additional variable, called y, along with the other seeds. In order to withdraw 2^{l} coins, the following steps must be taken. Note that in this protocol, Alice can only withdraw a wallet containing 2^{l} coins due to the nature of the zero-knowledge proof of knowledge of the value of the internal counter of the coins J.

Alice identifies herself to the bank by proving knowledge of skᵤ using the zero-knowledge proof described in the definitions in the preliminary section. Alice and the bank now generate the wallet secrets in the following way. Alice selects random values s′, t, \dot{r}∈ [symbol] ₘ and sends the Pedersen Commitment

A′=PedCom(u,s′,t,y)= [symbol] _{\dot{r}} [symbol] ₁^{u} [symbol] ₂^{s′} [symbol] ₃^{t} [symbol] ₄^{y},

to the bank. The bank selects a random integer r′ to contribute to the wallet and sends this to Alice. Both the bank and Alice individually calculate

A= [symbol] ₂^{r′}A′=PedCom(skᵤ,s′+r′,t,y)=PedCom(skᵤ,s,t,y).

This step is essentially creating the wallet secrets, and having the bank contribute randomness to this. Alice and the bank run the CL signature protocol for obtaining the bank's signature on the values in the Pedersen Commitment A, resulting in a signature

σ_{B}(u,s,t,y)=(V,r,e),

where V=(a₁^{u}a₂^{s}a₃^{t}a₄^{y}b^{r}c)^{1/e}. The method for calculating this signature is given in the preliminaries section, where (x₁, x₂, x₃, x₄) are (u, s, t, y). Alice saves the wallet W=(u, s, t, y, σ_{B}(u, s, t, y),J), where J is an l-bit counter initialised to zero. Note that the signature by the bank is only on the wallet seeds s, t, y, such that serial numbers and the double-spending equations do not necessarily need to be stored in the wallet, and instead can be derived using the wallet seeds and the wallet counter when required. The bank records a debit of 2^{l} coins for the account corresponding to Alice.

At this point, the protocol splits into two, depending on whether one would like to spend the whole wallet at once, or n of the coins in the wallet. If Alice spends n coins, she can still spend the remaining coins as single CHL coins, or as another batch of size n′.

For compact spending, to spend the whole wallet, Alice and the merchant carry out the following steps. Alice sends=PedCom(s, t, u, y), where s, t, u are the same as in CHL, and y is another random number which is used to prevent double compact spending. Alice then also sends T_{c}=g^{u}g^{R/(y+1)}, and the proof that she has a signature from the bank σ_{B} on (s, t, u, y). Finally, Alice discloses s, t to the merchant. If the proof of the signature is valid and s, t is correct, then the merchant accepts the coins.

For batch spending, to spend n coins, they take the following steps. Alice sends the commitment C=PedCom(s, t, u, y, J) and Sᵢ=g^{1/(s+J+i+1)}, Tᵢ=g^{u}g^{R/(t+J+i+1)} for i=0, . . . , n−1.

She also sends the zero-knowledge proof of knowledge signature on (σ_{B}, s, t, u, y, σ_{J}, J, σ_{J+n-1}), where σⱼ and σ_{J+n-1} are signatures on the first and last value of the counter of the coins. The zero-knowledge proof of knowledge signature Φ is a signature proving knowledge of: a signature σ_{B} on (s, t, u, y), a signature σ_{J} on J, a signature σ_{jJ+n-1} on J+n−1, all the Sᵢ and Tᵢ for i=0, . . . , n−1, and that C is a commitment on the values (s, t, u, y, J). If this zero-knowledge proof of knowledge Φ holds, then the merchant accepts the coin.

In this protocol, the merchant gives the bank all the information about the coin, and the signature on the zero-knowledge proof of knowledge. If the merchant is depositing a batch spend, the bank must calculate all the serial numbers and double-spending equations to store them just as if they had been spent individually. They then store (Sᵢ, Tᵢ, R) where Sᵢ and Tᵢ are for all individual coins deposited and also store T_{c} in the case of compact spending. Then the equations to calculate the identity of a double-spender are the following. If Alice executes spent two compact spends

$${g}^{u} = {( {T}_{c}^{{R}^{′}} / {T}_{c}^{′ R} )}^{1 / ( {R}^{′} - R )} .$$

If Alice has double batch spent

$${g}^{u} = {( {T}^{{R}^{′}} / {T}^{′ R} )}^{1 / ( {R}^{′} - R )} .$$

If Alice has double spent a single coin in a compact spend then the bank can compute Alice's identity in the same way as CHL.

The OP_RETURN data is almost identical to CHL ecash as expected. Note that there's a slight modification to the protocol in the case of compact spending, that the merchant must calculate all the serial numbers rather than the bank. This is then published on chain in the spend transaction. If the merchant waits for the bank to calculate all the serial numbers, Alice could double-spend a single coin that was spent as a compact spend.

As with other protocols, this protocol prevents double-spending at the point of spend rather than deposit. Similar to the previous protocols, this is because merchants now have access to the database (the blockchain) of spent coins. They can check this database and reject coins that are already spent. Additionally, the identity of anyone that double-spends will now be calculable by anyone with access to the information on chain. This will deter anyone, since they risk ruining their reputation.

Brands Ecash (BRA)

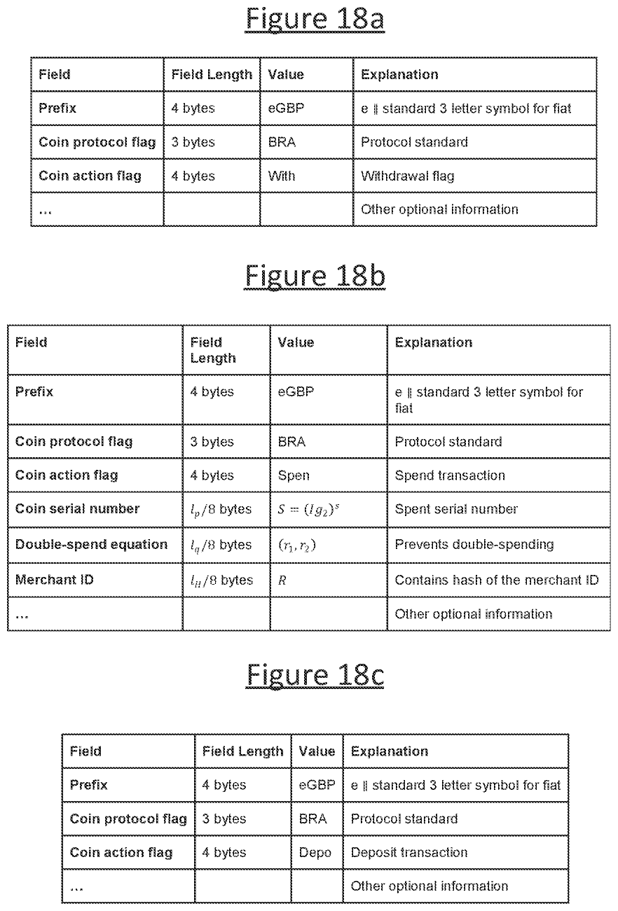

FIGS. 18a to 18c respectively illustrate example OP_RETURN data for withdrawal, spending and deposit transactions according to this protocol.

This offline ecash is computationally easier compared to CHL ecash with respect to the zero-knowledge proofs of knowledge, but with the result that only one coin can be withdrawn at one time.

Let p, q, g, g₁, g₂ be publicly known system parameters such that p, q are large primes with corresponding binary lengths lₚ, l_{q}, and g, g₁, g₂∈ [symbol] have order q. Then x∈ [symbol] is the private key of the bank and the public key is h=g^{x} mod p. Let u∈ [symbol] be the private key of Alice, and her public key is I=g₁^{u}. The bank computes z=(Ig₂)^{x} mod p and sends it to Alice. Alternatively, the bank can publish g₁^{x} and g₂^{x} as part of the public key, so the user can compute it themselves.

Alice would like to withdraw a coin from the bank. The bank generates a random number w∈ [symbol] _{q} which the bank keeps secret and sends a=g^{w} and b=(Ig₂)^{w} to Alice. Alice sends a blind coin to the bank to obtain the Schnorr signature by the bank in the following way. Alice generates three numbers at random s∈ [symbol] , and x₁, x₂∈ [symbol] _{q}. Alice computes S=(Ig₂)^{s}, B=g₁^{x}^{₁}g₂^{x}^{₂}, and z′=z^{s}. S is the serial number of the coin, B will be used in the zero-knowledge proof of the seed of the coin, and z′ will form part of the Schnorr signature. Alice generates two more random numbers μ, ν∈Z_{q} and computes a′=a^{μ}g^{ν} and b′=b^{sμ}S^{ν}. These two values will also form part of the Schnorr signature. Alice finally computes the challenge c′=H(S, B, z′, a′, b′) where H is some collision-free hash function leading to an l_{H}-bit output. Alice then sends the blinded challenge c=c′μ⁻¹ mod q to the bank. Note that Alice will give c′ to the merchant who returns this to the bank, but the key point is that the bank cannot identify which c and c′ are related, and so cannot connect the deposit to Alice's withdrawal. The bank responds with r=cx+w mod q and debits Alice account. Alice accepts provided that g^{r}=h^{c}a and (Ig₂)^{r}=z^{c}b. Alice then computes r′=rμ+ν mod q. This is the final part of the signature. Finally, the signed coin is (S, B, σ(S, B)=(z′, a′ b′ r′)).

If Alice would like to spend a coin with a merchant, they execute the following steps. In order to spend the coin (S, B, σ(S, B)), Alice first sends it to the merchant. The merchant checks if S≠1, then computes and sends the challenge R=H₀(S, B, ID_{M}, date/time) to Alice, where H₀ is another collision-free hash function, ID_{M} is the identity of the merchant, and date/time represents when the transaction occurs. Alice computes r₁=R(us)+x₁ mod q, and r₂=Rs+x₂ mod q and sends the responses to the merchant. The merchant finally checks that g₁^{r}^{₁}g₂^{r}^{₂}=S^{R}B, and the signature sig(S, B) is valid, that is if

g^{r′}=h_{c′}a′ mod p,

A^{r′}=(z′)^{c′}b′ mod p,

c′=H(S,B,z′,a′,b′),

hold, then merchant accepts the coin.

The merchant sends the bank the payment transcript consisting S, B, σ(S, B), (r₁, r₂) and the date and time of the transaction. If S=1, the bank refuses the deposit. If not, the bank then follows the transcript, verifying the same information, using the identity of the merchant who sent the transcript. If this verifies, then the bank checks if S has been stored before. If not, then the bank stores (S, date/time, r₁, r₂, R) and credits the merchants account. If S has appeared previously, the bank determines the identity of the double-spender in the following way. If the date/time data is the same, the bank knows the merchant is the double-spender and immediately rejects the coin. If the time is different, the bank knows that the user is the double-spender. They can use (r₁, r₂, R) and (r₁′, r_{2′}, R′) to calculate the private key u, using (r₁−r₁′)/(r₂−r₂′). The bank can then find the identity of the double-spender by calculating I=g₁^{u}.

Again, moving this protocol on chain shifts the double-spending detection to the point of spending. This means that double-spending will never occur as it will be immediately detected. As well as this, the identity of anyone who attempts to double-spend will be derivable by anyone with access to the blockchain. Like other protocols, this will deter users from double-spending, to protect their reputation.

Recoverable Ecash (LTW)

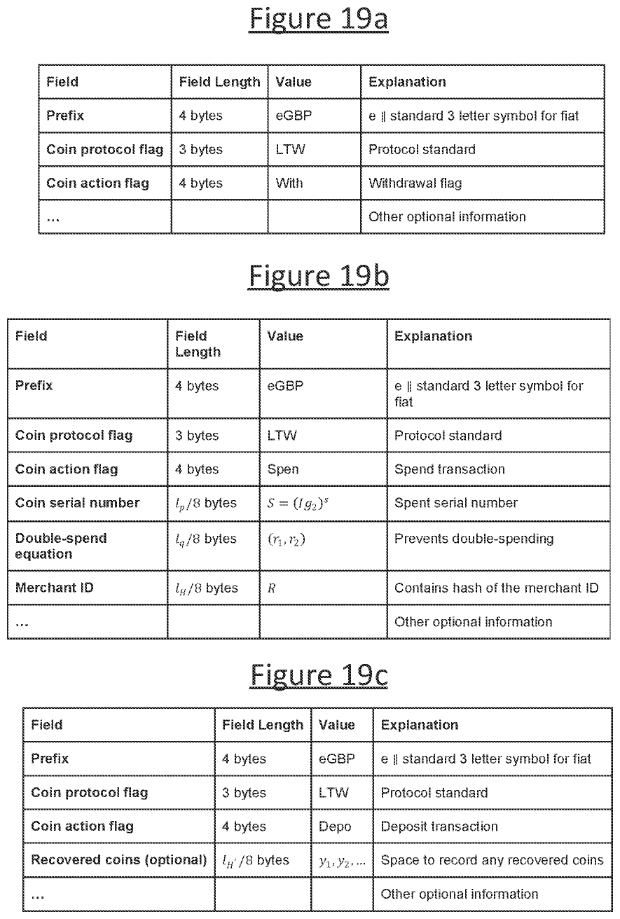

FIGS. 19a to 19c respectively illustrate example OP_RETURN data for withdrawal, spending and deposit transactions according to this protocol.

This protocol is an extension to the Brands protocol, which adds a recovery centre to the protocol such that Alice can recover her lost coins. This extension can actually be applied to any protocol where the coins are not divisible or transferable, as are all the protocols described here.

This protocol has the same parameters as Brands. That is, let p, q, g, g₁, g₉₂ be publicly known system parameters such that p, q are large primes with corresponding binary lengths lₚ, l_{q}, and g, g₁, g₂∈ [symbol] have order q. Then x∈ [symbol] is the private key of the bank and the public key is h=g^{x} mod p. Let u∈ [symbol] be the private key of Alice, and her public key is I=g₁^{u}. The bank computes z=(Ig₂)^{x} mod p and sends it to Alice. Alternatively, the bank can publish g₁^{x} and g₂^{x} as part of the public key, so the user can compute it themselves. In this protocol, there is another entity which we call the recovery centre (RC). Assume that Alice communicates with the RC through an anonymous channel.

In order to withdraw n coins, Alice carries out the following steps. First, execute the protocol as in Brands' ecash to obtain (Sᵢ, Bᵢ, σ(Sᵢ, Bᵢ)) for i=1, . . . , n where n is the number of coins. RC prepares n numbers x₁, . . . , xₙ such that Hₙ(x₁)=Hₙ(x₂)= . . . =Hₙ(xₙ)=y, where Hₙ is defined to be an n-collision cryptographic hash function, which results in a l_{H′}-bit output. This means that the RC is able to find n inputs that result in the same output of this hash function. On the other hand, it is difficult for an adversary to find the preimage if they know only y. Alice sends the coins (Sᵢ, Bᵢ, σ(Sᵢ, Bᵢ)) to RC and records the serial numbers Sᵢ. RC checks the signature for each i. If it is valid, RC computes S_{c}_{ᵢ}=σ_{RC}(Sᵢ, Bᵢ, σ(Sᵢ, Bᵢ), xᵢ. RC sends backs xᵢ, S_{c}_{ᵢ}. Alice attaches to the coin. RC computes another signature S_{b}=σ_{RC}(y, n) and sends S_{b}, y to Alice. Alice saves this securely for recovery purposes.

In order to spend a coin with a merchant, Alice does the following. Alice and the merchant execute the payment protocol in the same way as in Brands. The merchant then checks if S_{c}_{ᵢ} is a valid signature on (Sᵢ, Bᵢ, σ(Sᵢ, Bᵢ), xᵢ). The merchant computes y=H′(xᵢ) and checks whether y is on the blacklist, which is a list of all coins reported to the bank as lost. If these checks all verify, then the merchant accepts the coin.

To deposit a coin with the bank, the following steps are completed. The merchant and the bank execute the deposit as in Brands. Additionally, the bank checks if the hash value of xᵢ each coin is in the blacklist. If it is not, the coin is accepted.

In order to recover lost coins, Alice must do the following steps. Alice reveals her identity to bank and sends (S_{b}, y) to them. The bank checks whether S_{b} is a valid signature on (y, n). The bank checks the database to find all coins with their H′ value equal toy. The maximum number of coins should be n. These are the coins which have already been spent. The bank computes the difference between the total amount of coins and the amount spent and returns the difference in the value. To prevent double-spending, this y is then added to a publicly available blacklist. If any customer tries to spend the refunded coins, the merchant will not accept the transaction. This is very similar to Brands′. The difference is that there is additional space for broadcasting recovered coins.

This protocol already has a notion of a database that merchants can check for blacklisted coins. So, on top of being able to detect double-spending earlier in a similar way to the other ecash on chain, moving this protocol on chain naturally incorporates these spent coins into the same list as the other blacklisted coins.

Bounded Accumulator Ecash (ACC)

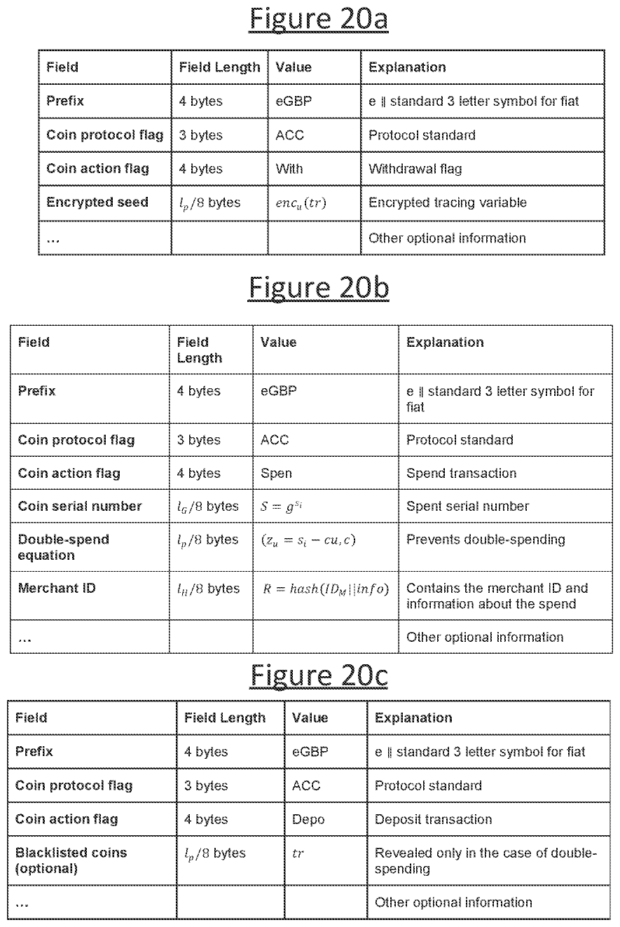

FIGS. 20a to 20c respectively illustrate example OP_RETURN data for withdrawal, spending and deposit transactions according to this protocol.

This protocol makes storing coins more efficient and involves a bounded accumulator. An accumulator is the concept of storing an arbitrary number of values within the same size storage, where there is a witness if a value is added, and no witness if a value isn't added to the accumulator. The notion of a bounded accumulator is simply that of an accumulator, plus having an upper bound to the number k of values that can be added to the accumulator.

Assume that g, h∈G are generators of G, with order p. Assume that all elements of G have a unique binary representation of length l_{G}. First, the bank sets up a public/private key pair (x, g^{x}), and a Bounded Accumulator with upper bound k. Each user has public/private key pairs with the form (u, g^{u}).

In order to withdraw k coins, Alice executes the following steps. To withdraw, Alice generates k random numbers sᵢ. These random numbers will be used to generate the serial numbers of the coins. She accumulates the sᵢ's to form an accumulated value v and obtains k witnesses wᵢ. Then the bank signs σ_{B}=sig (v, commit(u)). The wallet is then of the form (σ_{B}, sᵢ, wᵢ, u) for i=1, . . . , k.

In order to spend a coin, Alice executes the following steps. Identity of the merchant is denoted by ID_{M}. Alice chooses an unused random number in her wallet and computes

S=g^{s}^{ᵢ},T=g^{r}^{₁}h^{s}^{ᵢ},Y=g^{r}^{₂}h^{u}

Alice generates a non-interactive zero-knowledge proof of knowledge π₁ of the following
verify(σ_{B}, v, commit(u))=1
sᵢ is in v using wᵢ as a witness
S, T, Y are correctly formed

Then Alice computes signature of knowledge πr₂ on the representation of Y using T as the commitment. This is computing zᵣ=r₁−cr₂, zᵤ=sᵢ−cu such that T=Y^{c}g^{z}^{ᵣ}h^{z}^{ᵤ} where c is the challenge used in the signature of knowledge. In both signatures π₁, π₂, the message to be signed is (ID_{M}∥info), where info is some information that changes with each transaction, such as transaction number, time and date.

To deposit the coin, the merchant gives the bank the communication transcript of the spend protocol. The bank verifies the transcript exactly as the merchant did. Additionally, the bank can verify that ID_{M} is the identity of the merchant and that (ID_{M}∥info) is not used before, to prevent double-spends and preventing malicious merchants from eavesdropping honest transactions and spending the coin. The bank stores (S, c, zᵤ) if these verify. In the case of double-spending, S exists in the database. The bank can then compute u using u=(zᵤ−z′ᵤ)/(c′−c). The output is the identity of the double-spender in the form g^{u}. If the zᵤ is the same, then the bank can assume that the merchant is acting maliciously by attempting a double deposit and the bank will reject the deposit.

This protocol can be extended to include tracing all coins of a double-spender in the following way. During withdrawal, Alice obtains a signature on (v, commit(u, tr)), where tr is a random number. Alice verifiably encrypts tr under her own private key u and the bank stores this encrypted value. During the spend protocol, Alice additionally computes a tracing R=H (ID_{M}∥info)^{tr} where H is a hash function resulting in a l_{H}-bit integer. Then the signature π₁ is modified to include
verify(σ_{B}, v, commit(u, tr))=1
sᵢ is in v using wᵢ as a witness
S, T, Y, R are correctly formed

If Alice double-spends, the bank can calculate u and then decrypt tr. They can then blacklist tr, and anyone can check if a user has is currently is spending with them and reject any further spending. At a point of sale, a merchant simply needs to check if tag=H(ID_{M}∥info)^{tr} is the same as what they have been presented with, for each blacklisted tr.

As with the other protocols, the detection of double-spending occurs at the point of spending, and so it prevents double-spending entirely. Aside from this, moving this protocol on chain allows anyone to identify a double-spender, which is a deterrent from users double-spending.

### CONCLUSION

It will be appreciated that the above embodiments have been described by way of example only. More generally there may be provided a method, apparatus or program in accordance with any one or more of the following Statements.

Statement 1. A computer-implemented method for implementing a system for issuing digital coins using a blockchain, wherein each digital coin is issued by an issuing party to a spending party, wherein each digital coin represents an amount of an asset redeemable by a redeeming party in exchange for the digital coin, wherein the issuing party maintains a record of coin serial numbers, each coin serial number representing a respective digital coin; the method being performed by the issuing party and comprising: obtaining a spending transaction, the spending transaction being a blockchain transaction and comprising a first one of a set of coin serial numbers; determining whether the first coin serial number is present in the database of spent coin serial numbers; and in response to one or more conditions being met, transferring the amount of the asset represented by the first coin serial number to the redeeming party, wherein a first one of the one or more conditions is that the first coin serial number is not present in the database.

The spending transaction is used to convey a token (sometimes referred to as a coin, e.g. Bitcoin) of the underlying blockchain (a “first system”) whereas the digital coin is part of a different system (an “electronic cash system”). That is, the spending, withdrawal and deposit transactions, by necessity, transfer ownership of an amount of token (e.g. Bitcoin) of the underlying blockchain, and are also used to transfer ownership of digital coins of the electronic cash system. Put another way, the coin serial numbers identify digital coins of the electronic cash system and not of the underlying blockchain system (e.g. not Bitcoin). Conventionally, an amount of blockchain token (e.g. Bitcoin) are not mapped to an individual identifier, wherein each digital coin of the present invention is individually identified by a respective coin serial number. Specifically, the coin serial number does not identify an amount of the underlying blockchain token (e.g. Bitcoin).

Statement 2. The method of statement 1, wherein the record of coin serial numbers is maintained on the blockchain.

Statement 3. The method of statement 1 or statement 2, wherein the spending transaction comprises an output locked to the issuing public key of the issuing party, and wherein said obtaining of the spending transaction comprises obtaining the spending transaction from the spending party and/or from the blockchain.

Statement 4. The method of statement 1 or statement 2, wherein the blockchain comprises a withdrawal transaction, the withdrawal transaction comprising one or more outputs, each output comprising an indication of a respective one of the set of coin serial numbers.

Statement 5. The method of statement 4, wherein the indication is a hash of a respective one of the set of coin serial numbers.

Statement 6. The method of statement 4 or statement 5, wherein the issuing party is associated with an issuing private-public key pair, and wherein the method comprises: generating the withdrawal transaction, the withdrawal transaction comprising an input comprising a signature generated based on the issuing private key; and transmitting the withdrawal transaction to the spending party, a third party, and/or to the blockchain network to be recorded in the blockchain.

For instance, the third party may be a service provider such as a wallet provider.

Statement 7. The method of any of statements 4 to 6, wherein a second one of the one or more conditions is that the spending transaction comprises an input for unlocking an output of a withdrawal transaction.

Statement 8. The method of statement 7, wherein the output of the withdrawal transaction is configured to require, when executed alongside an input of a later transaction, the input of the later transaction to require the first coin serial number.

Statement 9. The method of any of statements 6 to 8, wherein the spending party is associated with a spending private-public key pair, and wherein the output of the withdrawal transaction is configured to require, when executed alongside an input of a later transaction, the input of the later transaction to require a signature generated based on the spending private key.

Statement 10. The method of statement 3 or statement dependent thereon, wherein a third one of the one or more conditions is that the withdrawal transaction comprises an input comprising the signature generated based on the issuing private key.

Statement 11. The method of any preceding statement, wherein the redeeming party is associated with a redeeming private-public key pair, and wherein a fourth one of the one or more conditions is that the spending transaction comprises a further input, the further input comprising a signature generated based on the redeeming private key.

Statement 12. The method of any preceding statement, comprising: obtaining a deposit transaction, the deposit transaction comprising an input that references an output of the spending transaction and comprises one or more of: a signature generated based on the issuing private key, a signature generated based on the spending private key, and/or a signature based on the redeeming private key; and in response to one or more conditions being met, transmitting the deposit transaction to the redeeming party, a third party and/or to the blockchain network to be recorded in the blockchain.

Statement 13. The method of any preceding statement, comprising: obtaining a blinded version of a coin seed generated at least in part by the spending party, the coin seed being for generating a set of coin serial numbers, each coin serial number representing a respective digital coin; generating a blind signature of the coin seed; and transmitting the blind signature of the coin seed to the spending party.

In some examples, the blind signature may be of the coin serial number, which by extension is still on the seed.

Statement 14. The method of statement 13, wherein the coin seed is generated at least in part by the issuing party.

Statement 15. The method of any of statements 12 to 14, comprising: obtaining a candidate coin seed proof and/or a candidate coin seed signature proof, wherein the candidate coin seed proof represents knowledge of a candidate coin seed, and wherein the candidate coin seed signature proof represents knowledge of a candidate signature of the coin seed; and determining whether the candidate signature represented by the candidate seed proof is the blinded signature of the coin seed, wherein a fifth one of the one or more conditions is that the candidate signature represented by the candidate seed proof is the blinded signature of the coin seed; and/or determining whether the candidate coin seed represented by the candidate coin seed proof is the coin seed, wherein a sixth one of the one or more conditions is that the candidate coin seed is the coin seed.

The candidate coin seed proof and coin seed signature proof may be zero-knowledge proofs. In some examples, the candidate seed proof comprises the generated signature of the coin seed.

Statement 16. The method of any preceding statement, wherein the redeeming party is associated with a known identifier, and wherein the method comprises: obtaining a candidate identifier proof, wherein the candidate identifier proof represents knowledge of a candidate identifier of the redeeming party; and determining whether the candidate identifier represented by the candidate identifier proof is the known identifier of the redeeming party, and wherein a seventh one of the one or more conditions is that the candidate identifier represented by the candidate identifier proof is the known identifier of the redeeming party.

Statement 17. The method of any preceding statement, wherein the first coin serial number is associated with a respective counter value, and wherein the method comprises: obtaining a candidate counter proof, wherein the candidate counter proof represents knowledge of a candidate counter of the first coin serial number; and determining whether the candidate counter value represented by the candidate counter proof is within a predetermined range, and wherein an eighth one of the one or more conditions is that the candidate counter value represented by the candidate counter proof is within a predetermined range.

Statement 18. The method of any preceding statement, comprising: obtaining a blinded version of at least one double-spend seed generated by the spending party, the at least one double-spend seed being for generating at least one double-spend value, wherein each double-spend value is based on a double-spend seed, an identifier of the spending party and a respective data item chosen by the redeeming party, wherein each double-spend value reveals, for different respective data items, different components of the identifier of the spending party; generating a blind signature of the at least one double-spend seed; and transmitting the blind signature of the at least one double-spend seed to the spending party.

In some examples, the same signature signs the coin seed and the at least one double-spend seed.

Statement 19. The method of statement 18, comprising: obtaining a double-spend value; and in response to determining that the first coin serial number is present in the database of spent coin serial numbers, using the obtained double-spend value and a previously obtained double-spend value to reveal the identifier of the spending party.

Statement 20. The method of statement 4 and statement 19, wherein the withdrawal transaction comprises a plurality of outputs, each output comprising a hash of a respective one of the set of coin serial numbers, and each output being locked to the issuing public key, and wherein the method comprises, in response to determining that the first coin serial number is present in the database of spent coin serial numbers, spending each output locked to the issuing public key.

Statement 21. The method of statement 6 and statement 19, wherein the spending transaction comprises an output comprising a hash of a respective one of the set of coin serial numbers, and wherein the method comprises, in response to determining that the first coin serial number is present in the database of spent coin serial numbers, spending the output comprising the respective hash of the respective one of the set of coin serial numbers, and/or publishing respective ones of the set of coin serial numbers.

For example, the double spent coins may not yet be on chain, i.e. in some hash. This would be the case if the spending transaction contains the hash of the next coin, so not all coin serial number hashes are on chain yet. Therefore the bank may broadcast the serial numbers to prevent the next coins being spent.

Statement 22. The method of any preceding statement, wherein the issuing party maintains a record of identifier hashes, and wherein the method comprises comprising: obtaining an identifier hash, the identifier hash being a hash of at least an identifier of the redeeming party and a data item chosen by the redeeming party, and wherein a ninth one of the one or more conditions is that the obtained hash is not present in the database of identifier hashes.

Statement 23. The method of statement 22, wherein the record of identifier hashes is maintained on the blockchain.

Statement 24. A computer-implemented method for implementing a system for issuing digital coins using a blockchain, wherein each digital coin is issued by an issuing party to a spending party, and wherein each digital coin represents an amount of an asset redeemable by a redeeming party in exchange for the digital coin; the method being performed by the spending party and comprising: obtaining a withdrawal transaction, the withdrawal transaction comprising one or more outputs, each output comprising a hash of a respective one of a set of coin serial numbers, each coin serial number representing a respective digital coin; and transmitting the withdrawal transaction to the redeeming party, a third party, and/or to the blockchain network to be recorded in the blockchain.

Statement 25. The method of statement 24, wherein the spending party is associated with a spending private-public key pair, wherein said obtaining of the withdrawal transaction comprises generating the withdrawal transaction, and wherein the withdrawal transaction comprises an input comprising a signature generated based on the spending private key.

Statement 26. The method of statement 24, wherein the issuing party is associated with an issuing private-public key pair, wherein the withdrawal transaction is generated by the issuing party, wherein the withdrawal transaction comprises an input comprising a signature generated based on the issuing private key, and wherein said obtaining of the withdrawal transaction comprises obtaining the withdrawal transaction from the issuing party or from the blockchain.

Statement 27. The method of any of statements 24 to 26, wherein a first one of the one or more outputs of the withdrawal transaction comprises a hash of a first one of the set of coin serial numbers, and wherein the method comprises generating the first coin serial number based on a coin seed.

Statement 28. The method of statement 27, wherein the coin seed is generated at least in part by the issuing party.

Statement 29. The method of statement 24 or statement 28, comprising: transmitting a blinded version of the coin seed to the issuing party; and receiving a blind signature of the coin seed from the issuing party.

Statement 30. The method of statement 29, comprising: transmitting a coin seed proof to the redeeming party, wherein the coin seed proof represents knowledge of the blind signature on the coin seed.

Statement 31. The method of any of statements 24 to 30, wherein the first coin serial number is associated with a respective counter value, and wherein the method comprises transmitting a counter proof to the redeeming party, wherein the counter proof represents knowledge of a counter value of the first coin serial number.

Statement 32. The method of statement 27 or any statement dependent thereon, comprising: transmitting the first coin serial number to the redeeming party.

Statement 33. The method of any of statements 24 to 32, comprising: transmitting one or more double-spend values to the redeeming party, wherein the one or more double-spend values are based on one or more respective double-spend seeds, an identifier of the spending party and a respective data item chosen by the redeeming party, wherein each double-spend value reveals, for different respective data items, different components of the identifier of the spending party.

Statement 34. The method of statement 33, comprising, obtaining the respective data item from the redeeming party.

Statement 35. The method of statement 33 or statement 34, comprising: transmitting one or more double-spend value proofs to the redeeming party, wherein the one or more double-spend value proofs represent, respectively, knowledge of a signature on the double-spend value and/or knowledge of the one or more double-spend values.

Statement 36. The method of statement 35, wherein the double-spend value is associated with a double-spend counter value, and wherein the method comprises transmitting a double-spend counter proof to the redeeming party, wherein the double-spend counter proof represents knowledge of the double-spend counter value of the double-spend value.

Statement 37. The method of any of statements 24 to 36, comprising: obtaining a spending transaction, wherein the spending transaction comprises a first input for unlocking the first output of the withdrawal transaction, the first input comprising a signature generated based on the spending private key; and transmitting the spending transaction to the redeeming party, a third party, and/or to the blockchain network to be recorded in the blockchain.

Statement 38. The method of statement 37, wherein the first input of the spending transaction comprises the first coin serial number.

The serial number locking the output of the withdrawal transaction can be used to prevent a bank spending the withdrawal output (which is desirable in the case of double spending). Without the serial number locking the output, the bank can spend the output at any time rather than just in the event of double-spending. This is less secure but is not an issue if the bank is trustworthy. The coin serial number is also present in the OP_RETURN output of the spending transaction, so if it is not in the withdrawal transaction locking script, then it will still be found as spent in the OP_RETURN output.

Statement 39. The method of statement 37 or statement 38, wherein the spending transaction comprises a first output comprising a signature generated based on the redeeming private key.

Statement 40. The method of any of statements 37 to 39, wherein the spending transaction comprises a second output comprising a hash of a second one of the set of coin serial numbers.

Statement 41. A computer-implemented method for implementing a system for issuing digital coins using a blockchain, wherein each digital coin is issued by an issuing party to a spending party, and wherein each digital coin represents an amount of an asset redeemable by a redeeming party in exchange for the digital coin; the method being performed by the redeeming party and comprising: obtaining, from the spending party, a first coin serial number; determining whether the first coin serial number is present on the blockchain; and in response to one or more conditions being met, obtaining a spending transaction, the spending transaction being a blockchain transaction and comprising the first coin serial number, and transmitting the spending transaction to one or more of: the spending party, the issuing party, a third party, and/or the blockchain network to be recorded in the blockchain, wherein a first one of the one or more conditions is that the first coin serial number is not present on the blockchain.

Statement 42. The method of statement 41, wherein the redeeming party is associated with a redeeming private-public key pair, wherein the spending transaction comprises a first input comprising a signature generated based on the redeeming private key.

Statement 43. The method of statement 41 or statement 42, wherein the spending party is associated with a spending private-public key pair, wherein the spending transaction comprises a second input comprising a signature generated based on the spending private key.

Statement 44. The method of statement 43, wherein the second input of the spending transaction is configured to unlock an output of a withdrawal transaction.

Statement 45. The method of statement 44, wherein the second input comprises the first coin serial number.

Statement 46. The method of statement 44 or statement 45, wherein the issuing party is associated with a private-public key pair, wherein a second one of the one or more conditions is that the withdrawal transaction comprises an input comprising a signature generated based on the issuing private key.

Statement 47. The method of any of statements 41 to 46, comprising: obtaining a coin seed signature proof and/or a candidate coin seed proof from the spending party, wherein the coin seed signature proof represents knowledge of a blinded signature of a coin seed used to generate the first coin serial number, wherein the candidate coin seed proof represents knowledge of a candidate coin seed, wherein a second one of the one or more conditions is that the blinded signature is generated by the issuing party, and/or wherein a third one of the one or more conditions is that the candidate coin seed is the coin seed.

Statement 48. The method of any of statements 41 to 47, wherein the first coin serial number is associated with a respective counter value, and wherein the method comprises: obtaining a candidate counter proof, wherein the candidate counter proof represents knowledge of a candidate counter of the first coin serial number; and determining whether the candidate counter value represented by the candidate counter proof is within a predetermined range, and wherein a third one of the one or more conditions is that the candidate counter value represented by the candidate counter proof is within a predetermined range.

Statement 49. The method of any of statements 41 to 48, comprising: obtaining one or more double-spend values from the spending party, wherein the one or more double-spend values are based on a respective double-spend seed, an identifier of the spending party and a respective data item chosen by the redeeming party, wherein each double-spend value reveals, for different respective data items, different components of the identifier of the spending party.

Statement 50. The method of statement 49, comprising obtaining one or more double-spend seed proofs from the spending party, wherein the one or more double-spend seed proofs represents knowledge of a respective blinded signature of the one or more double-spend seeds used to generate the one or more double-spend values, wherein a fourth one of the one or more conditions is that the respective blinded signatures are generated by the issuing party.

Statement 51. The method of statement 49 or statement 50, wherein each double-spend value is associated with a respective double-spend counter value, and wherein the method comprises, for each double-spend value: obtaining a candidate double-spend counter proof, wherein the candidate double-spend counter proof represents knowledge of a candidate double-spend counter of that double-spend value; and determining whether the candidate double-spend counter value represented by the candidate double-spend counter proof is within a predetermined range, and wherein a fifth one of the one or more conditions is that the candidate double-spend counter values represented by the candidate double-spend counter proofs are within the predetermined range.

Statement 52. The method of any of statements 49 to 51, wherein the spending transaction comprises the obtained one or more double-spend values.

Statement 53. The method of any of statements 49 to 52, comprising generating the respective data item.

Statement 54. The method of any of statements 49 to 53, comprising transmitting the respective data item to the spending party.

Statement 55. The method of any of statements 41 to 54, comprising: obtaining an identifier hash from the spending party, the identifier hash being a hash of at least an identifier of the redeeming party and a data item chosen by the redeeming party; and transmitting obtained identifier hash to the issuing party.

Statement 56. The method of any of statements 41 to 55, comprising: obtaining a deposit transaction, the deposit transaction comprising an input that references an output of the spending transaction and comprises one or more of: a signature generated based on the redeeming private key, a signature generated based on the spending private key and/or a signature generated based on the issuing private key; and in response to the one or more conditions being met, transmitting the deposit transaction to the issuing party, a third party, and/or to the blockchain network to be recorded in the blockchain.

Statement 57. The method of statement 56, wherein the deposit transaction comprises an output locked the issuing public key.

Statement 58. The method of any of statements 41 to 57, comprising: in response to determining that at least one of the one or more conditions not being met, transmitting to the issuing party one or more of: the first coin serial number, the spending public key, the one or more double-spend values, and/or the identifier of the spending party.

Statement 59. Computer equipment comprising: memory comprising one or more memory units; and processing apparatus comprising one or more processing units, wherein the memory stores code arranged to run on the processing apparatus, the code being configured so as when on the processing apparatus to perform the method of any of statements 1 to 58.

Statement 60. A computer program embodied on computer-readable storage and configured so as, when run on computer equipment of statement 46, to perform the method of any of statements 1 to 58.

According to another aspect disclosed herein, there may be provided a method comprising the actions of the issuing party, the spending party, and the redeeming party.

According to another aspect disclosed herein, there may be provided a system comprising the computer equipment of the issuing party, the spending party, and the redeeming party.

Other variants or use cases of the disclosed techniques may become apparent to the person skilled in the art once given the disclosure herein. The scope of the disclosure is not limited by the described embodiments but only by the accompanying claims.

1. A computer-implemented method for implementing a system for issuing digital coins using a blockchain, wherein each digital coin is issued by an issuing party to a spending party, wherein each digital coin represents an amount of an asset redeemable by a redeeming party in exchange for the digital coin, wherein the issuing party maintains a record of coin serial numbers, each coin serial number representing a respective digital coin; the method being performed by the issuing party and comprising:
obtaining a spending transaction, the spending transaction being a blockchain transaction and comprising a first one of a set of coin serial numbers;
determining whether the first coin serial number is present in a database of spent coin serial numbers; and
in response to one or more conditions being met, transferring the amount of the asset represented by the first coin serial number to the redeeming party, wherein a first one of the one or more conditions is that the first coin serial number is not present in the database.

2. (canceled)

3. The method of claim 1, wherein the spending transaction comprises an output locked to an issuing public key of the issuing party, and wherein said obtaining of the spending transaction comprises obtaining the spending transaction from the spending party and/or from the blockchain.

4. The method of claim 1, wherein the blockchain comprises a withdrawal transaction, the withdrawal transaction comprising one or more outputs, each output comprising an indication of a respective one of the set of coin serial numbers.

5. The method of claim 4, wherein the indication is a hash of a respective one of the set of coin serial numbers.

6. The method of claim 4, wherein the issuing party is associated with an issuing private-public key pair, and wherein the method comprises:
generating the withdrawal transaction, the withdrawal transaction comprising an input comprising a signature generated based on the issuing private key; and
transmitting the withdrawal transaction to the spending party, a third party, and/or to a blockchain network to be recorded in the blockchain.

7. The method of claim 4, wherein a second one of the one or more conditions is that the spending transaction comprises an input for unlocking an output of a withdrawal transaction.

8. The method of claim 7, wherein the output of the withdrawal transaction is configured to require, when executed alongside an input of a later transaction, the input of the later transaction to require the first coin serial number.

9. The method of claim 6, wherein the spending party is associated with a spending private-public key pair, and wherein the output of the withdrawal transaction is configured to require, when executed alongside an input of a later transaction, the input of the later transaction to require a signature generated based on the spending private key.

10. The method of claim 6, wherein a third one of the one or more conditions is that the withdrawal transaction comprises an input comprising the signature generated based on the issuing private key.

11. The method of claim 1, wherein the redeeming party is associated with a redeeming private-public key pair, and wherein a fourth one of the one or more conditions is that the spending transaction comprises a further input, the further input comprising a signature generated based on the redeeming private key.

12. The method of claim 11, comprising:
obtaining a deposit transaction, the deposit transaction comprising an input that references an output of the spending transaction and comprises one or more of: a signature generated based on an issuing private key, a signature generated based on the spending private key, and/or a signature based on the redeeming private key; and
in response to one or more conditions being met, transmitting the deposit transaction to the redeeming party, a third party and/or to a blockchain network to be recorded in a blockchain.

13. The method of claim 1, comprising:
obtaining a blinded version of a coin seed generated at least in part by the spending party and at least in part by the issuing party, the coin seed being for generating a set of coin serial numbers, each coin serial number representing a respective digital coin;
generating a blind signature of the coin seed; and
transmitting the blind signature of the coin seed to the spending party.

14. (canceled)

15. The method of claim 13, comprising,
obtaining a candidate coin seed proof and/or a candidate coin seed signature proof, wherein the candidate coin seed proof represents knowledge of a candidate coin seed, and wherein the candidate coin seed signature proof represents knowledge of a candidate signature of the coin seed; and
determining whether the candidate signature represented by the candidate seed proof is the blinded signature of the coin seed, wherein a fifth one of the one or more conditions is that the candidate signature represented by the candidate seed proof is the blinded signature of the coin seed; and/or
determining whether the candidate coin seed represented by the candidate coin seed proof is the coin seed, wherein a sixth one of the one or more conditions is that the candidate coin seed is the coin seed.

16. The method of claim 1, wherein the redeeming party is associated with a known identifier, and wherein the method comprises:
obtaining a candidate identifier proof, wherein the candidate identifier proof represents knowledge of a candidate identifier of the redeeming party; and
determining whether the candidate identifier represented by the candidate identifier proof is the known identifier of the redeeming party, and wherein a seventh one of the one or more conditions is that the candidate identifier represented by the candidate identifier proof is the known identifier of the redeeming party.

17. The method of claim 1, wherein the first coin serial number is associated with a respective counter value, and wherein the method comprises:
obtaining a candidate counter proof, wherein the candidate counter proof represents knowledge of a candidate counter of the first coin serial number; and
determining whether the candidate counter value represented by the candidate counter proof is within a predetermined range, and wherein an eighth one of the one or more conditions is that the candidate counter value represented by the candidate counter proof is within a predetermined range.

18. The method of claim 1, comprising:
obtaining a blinded version of at least one double-spend seed generated by the spending party, the at least one double-spend seed being for generating at least one double-spend value, wherein each double-spend value is based on a double-spend seed, an identifier of the spending party and a respective data item chosen by the redeeming party, wherein each double-spend value reveals, for different respective data items, different components of the identifier of the spending party;
generating a blind signature of the at least one double-spend seed; and
transmitting the blind signature of the at least one double-spend seed to the spending party.

19. The method of claim 18, comprising:
obtaining a double-spend value; and
in response to determining that the first coin serial number is present in the database of spent coin serial numbers, using the obtained double-spend value and a previously obtained double-spend value to reveal the identifier of the spending party.

20-21. (canceled)

22. The method of claim 1, wherein the issuing party maintains a record of identifier hashes, and wherein the method comprises comprising:
obtaining an identifier hash, the identifier hash being a hash of at least an identifier of the redeeming party and a data item chosen by the redeeming party, and wherein a ninth one of the one or more conditions is that the obtained hash is not present in the database of identifier hashes.

23-58. (canceled)

59. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of implementing a system for issuing digital coins using a blockchain, wherein each digital coin is issued by an issuing party to a spending party, wherein each digital coin represents an amount of an asset redeemable by a redeeming party in exchange for the digital coin, wherein the issuing party maintains a record of coin serial numbers, each coin serial number representing a respective digital coin; the method being performed by the issuing party and comprising:
obtaining a spending transaction, the spending transaction being a blockchain transaction and comprising a first one of a set of coin serial numbers;
determining whether the first coin serial number is present in a database of spent coin serial numbers; and
in response to one or more conditions being met, transferring the amount of the asset represented by the first coin serial number to the redeeming party, wherein a first one of the one or more conditions is that the first coin serial number is not present in the database.

60. A computer program embodied on a non-transitory computer-readable storage medium and configured so as, when run on computer equipment, the computer equipment performs a method implementing a system for issuing digital coins using a blockchain, wherein each digital coin is issued by an issuing party to a spending party, wherein each digital coin represents an amount of an asset redeemable by a redeeming party in exchange for the digital coin, wherein the issuing party maintains a record of coin serial numbers, each coin serial number representing a respective digital coin; the method being performed by the issuing party and comprising:
obtaining a spending transaction, the spending transaction being a blockchain transaction and comprising a first one of a set of coin serial numbers;
determining whether the first coin serial number is present in a database of spent coin serial numbers; and
in response to one or more conditions being met, transferring the amount of the asset represented by the first coin serial number to the redeeming party, wherein a first one of the one or more conditions is that the first coin serial number is not present in the database.
